(19) United States
(12) Patent Application Publication
(10) Pub. No.: US 2007/0198391 A1
(43) Pub. Date: Aug. 23, 2007

(54) Method and system for conducting a block auction

(75) Inventors: Ralf Dreyer, Kelkheim (DE); Axel P. Vischer, Bad Soden (DE)

Correspondence Address: NIXON PEABODY, LLP, 401 9TH STREET, NW, SUITE 900, WASHINGTON, DC, 20004-2128, US

(73) Assignee: DEUTSCHE BOERSE AG, Frankfurt/Main (DE)

(21) Appl. No.: 11/357,438

(22) Filed: Feb. 21, 2006

(51) Int. Cl. G06Q 40/00

(52) U.S. Cl. 705/37

(57) ABSTRACT

The present invention relates to a system and method for performing a block auction. In a block auction, a block request is enabled to be executed against the plurality of quotes of different bidders, which comprise at least a part of the request volume. In accordance with the present invention, neither specification of the trade side of the request nor publication of the individual quotes submitted by bidders are required for performing the auction at an electronic trading system. Therefore, the auction can be performed anonymously and the trading of block requests comprising large volumes is enabled.

### FIELD OF THE INVENTION

The present invention relates generally to electronic auction systems for the financial market and in particular to a method and electronic trading system for conducting a block auction.

### BACKGROUND OF THE INVENTION

In a stock or derivative exchange, or a similar auction market, it is necessary to match buy orders with offers to sell in order to arrive at a price at which a sale can be completed. In the past, the matching of buy and sell orders or requests and bids has been carried out by human market makers, such as brokers. Brokers represent clients in buying or selling financial products through a particular exchange, as well as in obtaining market information from the exchanges for clients regarding market activity. A transaction may be completed, whenever one or more buy and sell orders can be matched with respect to price.

A particular kind of trading financial products is the so-called block trade, wherein a large volume of a financial product is traded, upon a single request (block request). A block trade typically comprises at least 10,000 shares of stock or $200,000 in bonds. Due to the large volume, block trades can affect the market price of the product, depending on the liquidity of the market.

Efficient and profitable trading in global markets requires high-speed matching of transactions. Therefore, in recent years, automation of trade processes performed manually before becomes more and more popular and electronic trading systems are going on to replace traditional floor trading at the stock exchange. Typically, electronic trading systems have a central server associated with a plurality of remote terminals through which trades can be made.

A conventional electronic trading system employed at an electronic stock exchange is capable of matching a plurality of requests for a product against a plurality of bids for the same product. Both requests and bids comprise volume and price information that are used by the electronic trading system to find matching requests and bids, i.e. bids and requests that can be executed against each other. An average price level of the executed trade is determined and displayed, so as to reflect the current market value of the product. An electronic trading system known in the art is moreover capable of automatically clearing the executed trade.

It is a drawback of a conventional electronic trading system that a conventional electronic trading system is not capable of arranging a block trade by automatically matching block requests. Block requests are requests, wherein a single (monopolistic) market participant, the requester, wants to execute a large volume of a product (a block) at the best price currently achievable. Normally only institutional investors undertake such large trades. Due to the large trade volume, a block trade performed on a block request requires particular trustworthiness of trading partners and anonymity to the market. Specifically, public announcement of a block request to be traded, including price and side information of the desired trade, may considerably influence the whole market situation for the trade product, and consequently has to be avoided.

Block requests are therefore currently usually traded off-exchange, in the OTC-market (over-the-counter). In the OTC-market brokers manually arrange trades between the counterparties. In particular, a broker aggregates volumes and prices to satisfy the demand of a block requester. Thereby an execution against different bidders at different prices is possible, if no single matching bid is available for the total volume of the block request. The broker will deal only with clients, with which he has a good business relationship, but never will communicate the name of the client. Thereby the broker is capable of evaluating trustworthiness and guarantees anonymity.

The process of getting large orders filled in the OTC-market by a broker is time consuming. Although conventionally electronic trading systems include the functionality of automatically clearing a prearranged OTC-trade between bilateral partners, it is therefore desirable to automatize also the matching process for enabling a multilateral trade, i.e. execution of a block request against multiple quotes, by an electronic trading system.

The desired functionality also can not be achieved by electronic auction systems known in the art. In a conventional auction, the traded product can be executed only against a single bidder, and no matching is required. In a conventional auction, moreover, the side of the trade is known in advance and the individual bids must be communicated, in order to achieve the best execution price.

### SUMMARY OF THE INVENTION

It is an object of the present invention to provide a method and a system for automatically enabling the execution of a block request.

A further object of the present invention is to provide a method and a system for performing an auction, wherein a predetermined volume of a product can be executed in parts, against a plurality of bidders.

Still a further object of the present invention is to provide a method and system for performing an auction, such that the individual quotes of the bidders are kept anonymous from each other.

It is moreover an object of the present invention to provide an auction system and auction method suitable for a block request, wherein the side of the requested trade is not communicated to the market.

This is achieved by the features of the independent claims. Further objects and advantages of the present invention are set forth in dependent claims.

According to a first aspect of the present invention, a method of performing a block auction in an electronic trading system is provided. The method enables execution of a single block request comprising a predetermined volume of a product against quotes of a plurality of market participants responding to the block request. A plurality of quotes is received in response to the block request for at least a part of the request volume, wherein the quotes include price and volume information. The method determines an indicative auction price by matching at least a part of the volume of the block request with the volumes and prices of the quotes, wherein the indicative auction price is an indicator of the current market situation on the basis of the received quotes. Further, the method notifies the auction participants of the indicative auction price. Moreover, the method receives modified quotes and notifies of the current indicative auction price updated on the basis of current quotes. The method terminates the block auction by accepting the block trade for execution based on matching quotes underlying a current indicative auction price.

According to a second aspect of the present invention, an electronic trading system for performing a block auction enabling execution of a single block request comprising a predetermined volume of a product against quotes of a plurality of market participants responding to the block request is provided. The system comprises a block request interface for receiving a block request including information of a predetermined volume of a product. The system further comprises a block request memory for storing data representing the received block request. Moreover, the system comprises a quote interface for receiving a plurality of quotes for at least a part of the predetermined volume in response to the block request, wherein the quotes include price and volume information. The system moreover includes a quote memory for storing data representing the received quotes. Furthermore, the system comprises a processor for determining an indicative auction price by matching at least a part of the volume of the block request stored in the block request memory with the volumes and prices of the quotes stored in the quote memory. The indicative auction price is an indicator of the current market situation on the basis of the received quotes. The processor permanently updates the indicative auction price to determine a current indicative auction price when the quote interface receives new or modified quotes. The system further comprises a notifying interface for notifying the auction participants of the determined current indicative auction price, and a terminating unit for terminating the block auction by accepting the block trade based on matching quotes underlying a current indicative auction price.

It is the particular approach of the present invention to enable execution of a block request in an electronic trading system. Therefore a block auction is performed to determine matching quotes among a plurality of quotes submitted in response to the block request. An indicative auction price is determined that indicates the price level at which the block request would be executed in case of acceptance of execution. The indicative auction price is moreover communicated to the auction participants, which are allowed to modify their quotes reacting on a currently determined indicative auction price, which is subsequently updated. Thereby a realistic price for execution is established in an inter-active process, without requiring any personal interaction of the market participants with each other or via a broker. Moreover, according to the present invention the number of potential bidders responding to a block request is considerably increased compared to OTC trade initiated via a broker. While a broker will contact only those trading partners whom he personally knows and considers trustworthy, in the block auction of the present invention all authorized participants of the electronic trading system become potential bidders. Accordingly, the chances for a requester to get the whole volume of the request executed increase considerably.

Preferably, notification of the auction participants of the price and volume information of the individual quotes is inhibited. Thereby the anonymity is achieved that is required in trading a block request.

Preferably the step of accepting the execution is performed automatically. Thereby the present invention accelerates the trading process.

According to a preferred embodiment, the block request does not comprise side information indicating the side of the trade triggered by the block request. Accordingly, an undesired influence on the market is automatically avoided.

Preferably, the method of the present invention comprises the step of notifying the market participants about the block request. Thereby the market participants get informed of the pending block requests, without any specific enquiry procedure being necessary.

According to another preferred embodiment, block requests include side information, which indicates the side of the trade triggered by the block request. In order to keep the side information anonymous, and not to influence the market, according to the preferred embodiment the side information is extracted from block request data before notifying the market participants.

More preferably, the block request further includes a price limit condition that is to be kept anonymous, therefore, the price limit condition is extracted from the block request data before notifying the market participants of the block request.

Preferably, execution of the block request is accepted automatically, provided that the indicative auction price fulfils the price limit condition of the block request.

According to a preferred embodiment, the block request further includes a limit volume being less than or equal to the request volume. The limit volume enhances flexibility as it forms a further basis for accepting the auction if, for instance, the complete volume is not executable at a price that is acceptable for the requester. Therefore, an indicative auction price is preferably determined by matching the limit volume with the volumes and the prices of the quotes.

In order not to influence the market, the limit volume is preferably kept anonymous. Therefore, the limit volume is extracted from the block request data before notifying the market participants of the block request.

In case the block request comprises both a price limit condition and a limit volume, more preferably, accepting the execution is automatically performed, provided that the indicative auction price fulfils the price limit condition and that the limit volume is completely executable.

According to a preferred embodiment the quotes comprise side information. An indicative bid price is determined as a first indicative auction price by matching the bid quotes with the request volume, and an indicative ask price is determined as a second indicative auction price by matching the ask quotes with the request volume.

More preferably, the step of accepting the block trade for execution is performed by selecting either the current indicative bid price or the current indicative ask price. Thereby the side of the block trade is automatically defined as either selling or buying, respectively.

Alternatively, accepting the block trade for execution can be performed by defining any other price than the current indicative bid price and the current indicative ask price. In this case, the side of the block trade must be specified together with the other price. Accordingly, the execution of at least a part of the request volume matching with quotes on the basis of the other price is accepted. Preferably, the block request includes a limit volume, and the execution of said limit volume against matching quotes on the basis of the other price is accepted.

More preferably, the other price must be larger than the indicative bid price, if the side of the block trade is specified as selling, and the other price must be smaller than the indicative ask price, if the side of the block trade is specified as buying. Accordingly, entering another price than an indicative auction price can lead only to an improvement of the price achievable for a requester.

Preferably, all quotes received in response to the block request comprise a bid quote and an ask quote. As no side information of the block request is available to the bidders during the auction, realistic prices without undesired market influence can be determined for both sides of the trade.

According to a preferred embodiment, an auction participant receives a notification, whether the current quote received from the auction participant is marketable. The received information serves as a further orientation for a possible modification of the placed quote of an auction participant. If a block request further comprises side information, the marketability is preferably nevertheless determined and notified for both the ask quotes and the bid quotes, without taking into account the side information of the block request. The side information is thereby kept anonymous by the system. Otherwise, if only one-sided marketability information would be generated and notified to the bidders, this could be seen as a hint towards the intended side of the block request, which would considerably influence the market.

According to a preferred embodiment of the present invention, the indicative auction price is determined as the volume weighted average price of the matching current quotes. Thereby, the auction price corresponds to the average price that would be achieved by the requester by accepting the execution on the basis of the current indicative auction price.

According to an alternative embodiment, the indicative auction price is determined as the price of the matching quote that allows to fill the request volume or (if the request volume cannot be filled by the available quotes) that maximizes the available volume. Depending on the side of the trade, this is the cheapest matching quote (for a selling request) or the most expensive matching quote (for a buying request). Accordingly, no quote would be executed at a price that is worse that the indicative auction price, if execution would be accepted on the basis of the current indicative auction price.

Preferably, the present invention further determines a current executable volume together with the indicative auction price on the basis of the currently existing quotes, and notifies the auction participants thereof. Accordingly, an information is available to the auction participants whether the complete volume of the block request is currently executable. More preferably, the current executable volume is determined as the total volume of all currently matching quotes that would be executable.

Preferably, according to the present invention block requests are rejected if the request volume is smaller than a predetermined minimum request volume. More preferably, quotes that are smaller than a predetermined minimum quote volume are rejected, wherein the minimum quote volume is smaller than the minimum request volume. Accordingly, the specific of a block trade as a trade involving a large trade volume is reflected.

Preferably, according to the present invention modification of the quotes is allowed during a preset time window which is terminated upon expiry of a timer or in case of acceptance of execution. Accordingly, speeding up of the auction process is achieved.

More preferably, the length of the predetermined time window is adjusted dependent on the request volume.

More preferably, the step of determining an auction price is iteratively repeated during the time window in order to permanently update the auction price. More preferably, during the predetermined time window also deleting the quote and modifying a price limit condition of the block request are allowed.

According to a more preferred embodiment of the present invention, the predetermined time window comprises a first time window and a subsequent second time window. While modification of a quote is acceptable during both the first and second time windows, additional quotes from new market participants are accepted only during the first time window, but rejected during the second time window. Accordingly, the number of auction participants is restricted after the first time window has expired, in order to improve chances to arrive at a matching result that is acceptable for an execution.

More preferably, it is also inhibited to delete an existing quote during the second time window. Accordingly, bidders are forced to submit serious quotes, which represent serious trade opportunities. Misuse of the auction process is consequently avoided.

Preferably, according to the present invention, rating information of a requester who places a block request is communicated to the market participants. The rating information indicates the reliability of the requester.

More preferably, data reflecting the behaviour of the requester during a plurality of auctions are stored in the electronic trading system, and the rating information is generated and updated on the basis of the stored data. Still more preferably, the rating information comprises the percentage of accepted auctions through block requests received from the requester.

According to a third aspect of the present invention, a method of performing a block auction in the electronic trading system is provided. The method enables execution of a single block request comprising a predetermined volume of a product against quotes of a plurality of market participants responding to the block request. The market participants are notified about the block request, wherein the notification does not include any side information of the block request. A plurality of quotes is received in response to the block request for at least a part of the request volume, wherein the quotes include price, volume and side information, the side information indicating whether the quote is a bid quote or an ask quote. The method determines an indicative bid price and an indicative ask price by matching at least a part of the volume of the block request with the volumes and prices of the received bid quotes and the received ask quotes, respectively. The indicative ask price and the indicative bid price are an indicator of the current market situation on the basis of the received quotes. The method terminates the block auction by accepting the block trade for execution based on matching quotes underlying current indicative bid and ask prices.

According to a fourth aspect of the present invention, an electronic trading system for performing a block auction enabling execution of a single block request comprising a predetermined volume of a product against quotes of a plurality of market participants responding to the block request is provided. The system comprises a block request interface for receiving a block request including information of a predetermined volume of a product. The system further comprises a block request memory for storing data representing the received block request. Moreover, the system comprises a notifying interface for notifying the market participants about the block request, wherein the notification does not include any side information of the block request. Further, the system comprises a quote interface for receiving a plurality of quotes for at least part of the request volume in response to the block request, wherein the quotes include price, volume and side information. The side information indicates whether the quote is a bid quote or an ask quote. The system moreover includes a quote memory for storing data representing the received quotes. Furthermore, the system comprises a processor for determining an indicative bid price and an indicative ask price, by matching at least a part of the volume of the block request with the volumes and prices of the received bid quotes and the received ask quotes, respectively. The indicative bid price and the indicative ask price are an indicator of the current market situation on the basis of the received quotes. The system further comprises a terminating unit for terminating the block auction by accepting the block trade for execution based on matching quotes underlying current indicative bid and ask prices.

It is the particular approach of the present invention according to the third and fourth aspects to enable execution of a block request in an electronic trading system without communicating side information of the request to the market. Accordingly, a block auction is performed, wherein a plurality of quotes for both sides of trade is received in response to the block request. Two indicative auction prices are determined, one for a selling request and one for a buying request, that indicate the price level at which the block request would be executed in case of acceptance of execution. Thereby a realistic market price for a large block can be achieved without influencing the marked by communicating the side of the block request.

Preferably, all quotes received in response to the block request comprise a bid quote and an ask quote at the same time. Thereby a stable basis is provided for determining realistic prices without undesired market influence can be determined for both sides of the trade.

Preferably, the auction participants are notified of the determined indicative bid and ask prices. More preferably, modifications of the quotes are allowed, and the auction participants are notified of current indicative bid and ask prices updated on the basis of the current quotes. Thereby a self-consistent price determination procedure is performed.

Preferably, notification of the auction participants of the price and volume information of the individual quotes is inhibited. In an electronic trading system according to the present invention this is preferable achieved in that the quote memory is adapted to inhibit the market participants from accessing the data of the individual quotes. Thereby the anonymity is achieved that is required in trading a block request.

Preferably the step of accepting the execution is performed automatically. Thereby the present invention eliminates any time consuming external decision process.

According to a preferred embodiment, the block request does not comprise side information indicating the side of the trade triggered by the block request. Accordingly, an undesired influence on the market is automatically avoided.

According to another preferred embodiment, block requests include side information, which indicates the side of the trade triggered by the block request. In order to keep the side information anonymous, and not to influence the market, the side information is extracted from block request data before notifying the market participants.

More preferably, the block request further includes a price limit condition that is to be kept anonymous, therefore, the price limit condition is extracted from the block request data before notifying the market participants of the block request.

Preferably, execution of the block request is accepted automatically, provided that the indicative auction price fulfils the price limit condition of the block request.

According to a preferred embodiment, the block request further includes a limit volume being less than or equal to the request volume. The limit volume enhances flexibility as it forms a further basis for accepting the auction if, for instance, the complete volume is not executable at a price that is acceptable for the requester. Therefore, an indicative auction price is preferably determined by matching the limit volume with the volumes and the prices of the quotes.

In order not to influence the market, the limit volume is preferably kept anonymous. Therefore, the limit volume is extracted from the block request data before notifying the market participants of the block request.

In case the block request comprises both a price limit condition and a limit volume, more preferably, accepting the execution is automatically performed, provided that either the indicative bid price or the indicative ask price fulfils the price limit condition and that the limit volume is completely executable.

According to an alternative preferred embodiment, the step of accepting the block trade for execution is performed by selecting either the current indicative bid price or the current indicative ask price. Thereby the side of the block trade is automatically defined as either selling or buying, respectively.

Still alternatively, accepting the block trade for execution can be performed by defining any other price than the current indicative bid price and the current indicative ask price. In this case, the side of the block trade must be specified together with the other price. Accordingly, the execution of at least a part of the request volume matching with quotes on the basis of the other price is accepted. Preferably, the block request includes a limit volume, and the execution of said limit volume against matching quotes on the basis of the other price is accepted. Preferably, the other price must be larger than the indicative bid price, if the side of the block trade is specified as selling, and the other price must be smaller than the indicative ask price, if the side of the block trade is specified as buying. Accordingly, entering another price than an indicative auction price can lead only to an improvement of the price achievable for a requester.

According to a preferred embodiment, an auction participant receives a notification, whether the current quote received from the auction participant is marketable. The received information serves as a further orientation for a possible modification of the placed quote of an auction participant. If a block request further comprises side information, the marketability is preferably nevertheless determined and notified for both the ask quotes and the bid quotes, without taking into account the side information of the block request. The side information is thereby kept anonymous by the system. Otherwise, if only one-sided marketability information would be generated and notified to the bidders, this could be seen as a hint towards the intended side of the block request, which would considerably influence the market.

According to a preferred embodiment of the present invention, the indicative bid and ask prices are determined as the volume weighted average prices of the matching current quotes of the respective side. Thereby, the indicative prices correspond to the average price that would be achieved by the requester by accepting the execution on the basis of the current indicative auction price.

According to an alternative embodiment, the indicative bid and ask prices are determined as the price of the matching quote that allows to fill the request volume or (if the request volume cannot be filled by the available quotes) that maximizes the available volume. Depending on the side of the trade, this is the cheapest matching quote (for a selling request) or the most expensive matching quote (for a buying request). Accordingly, no quote would be executed at a price that is worse that the indicative bid/ask price, if execution would be accepted on the basis of the current indicative price.

Preferably, the present invention further determines a current executable volume together with the indicative bid/ask price on the basis of the currently existing quotes, and notifies the auction participants thereof. Accordingly, an information is available to the auction participants whether the complete volume of the block request is currently executable. More preferably, the current executable volume is determined as the total volume of all currently matching quotes that would be executable.

Preferably, according to the present invention block requests are rejected if the request volume is smaller than a predetermined minimum request volume. More preferably, quotes that are smaller than a predetermined minimum quote volume are rejected, wherein the minimum quote volume is smaller than the minimum request volume. Accordingly, the specific of a block trade as a trade involving a large trade volume is reflected.

Preferably, according to the present invention modification of the quotes is allowed during a preset time window which is terminated upon expiry of a timer or in case of acceptance of execution. Accordingly, speeding up of the auction process is achieved.

More preferably, the length of the predetermined time window is adjusted dependent on the request volume.

More preferably, the step of determining an auction price is iteratively repeated during the time window in order to permanently update the indicative bid and ask prices. More preferably, during the predetermined time window also deleting the quote and modifying a price limit condition of the block request are allowed.

According to a more preferred embodiment of the present invention, the predetermined time window comprises a first time window and a subsequent second time window. While modification of a quote is acceptable during both the first and second time windows, additional quotes from new market participants are accepted only during the first time window, but rejected during the second time window. Accordingly, the number of auction participants is restricted after the first time window has expired, in order to improve chances to arrive at a matching result that is acceptable for an execution.

More preferably, it is also inhibited to delete an existing quote during the second time window. Accordingly, bidders are forced to submit serious quotes.

Preferably, according to the present invention, rating information of a requester who places a block request is communicated to the market participants. The rating information indicates the reliability of the requester.

More preferably, data reflecting the behaviour of the requester during a plurality of auctions are stored in the electronic trading system, and the rating information is generated and updated on the basis of the stored data. Still more preferably, the rating information comprises the percentage of accepted auctions through block requests received from the requester.

Further embodiments of the present invention are the subject matter of dependent claims.

### BRIEF DESCRIPTION OF THE DRAWINGS

In the accompanying drawings, preferred embodiments of the invention are described in more detail. The drawings are not to be construed as limiting the present invention to only the illustrated and described examples of how the invention can be made and used. Further features and advantages will become apparent from the following and more particular description of the invention, as illustrated in the accompanying drawings, wherein:

FIG. 1 schematically illustrates in block diagram form a hardware configuration of an electronic trading system according to the present invention;

FIG. 2 illustrates the system architecture of an electronic trading system that is embedded in a network environment, according to an embodiment of the present invention;

FIG. 3 illustrates in more detail a particular example of a distributed system architecture of an electronic trading system;

FIG. 4A is a block scheme illustrating the particular phases of a block auction according to the present invention;

FIG. 4B is a block scheme illustrating the detailed structure of the auction phase in accordance with an embodiment of the present invention;

FIG. 5 is a flow chart illustrating the processing flow between the phases of a block auction according to the present invention;

FIG. 6 is a flow chart illustrating the processing flow of a block auction according to an embodiment of the present invention;

FIG. 7 is a flow chart illustrating the processing during receiving a block request;

FIG. 8 is a flow chart illustrating the processing during receiving quote data;

FIGS. 9A, 9B and 9C present examples of data tables for determining auction prices on a volume weighted average price basis in a block auction in accordance with the present invention;

FIGS. 10A, 10B, 10C, and 10D present examples of data tables for determining auction prices on a volume clearing price basis in a block auction of the present invention; and

FIG. 11 is a data table illustrating the distribution of the executable volume among a plurality of bidders.

### DETAILED DESCRIPTION

The different aspects of the present invention will be described in the following with reference to the accompanying figure drawings, wherein like elements and structures are designated by like reference numerals.

In accordance with the present invention an electronic trading system and a corresponding method are provided for enabling execution of block requests by performing a block auction. A block request for a large contract size triggers an anonymous block auction. Bidders place their quotes in response to the block request, and an indicative auction price is determined on the basis of matching quotes, until the block trade is accepted for execution on the basis of the matching quotes underlying a current indicative auction price. Preferably, no information about the desired trade side of the block request (indicating whether the block request is for buying or selling) is provided to the market, as well as the data of the individual quotes of the bidders are kept anonymous to the auction participants. The auction result is an aggregated price (indicative auction price) for the volume requested. The aggregated price information and the executable volume are notified to the requester and the bidders. In this way the requester has an increased chance to execute his whole order and, at the same time, an increased chance to obtain a better price. The better price is achieved through the accumulation out of various smaller orders, which the bidders can place at potentially tighter spreads than the full order. The block auction processing of the present invention is particularly adapted for the derivatives market, without being limited to this kind of financial transactions. Products traded in a block auction according to the present invention include, but are not limited to options, futures, and strategy trading.

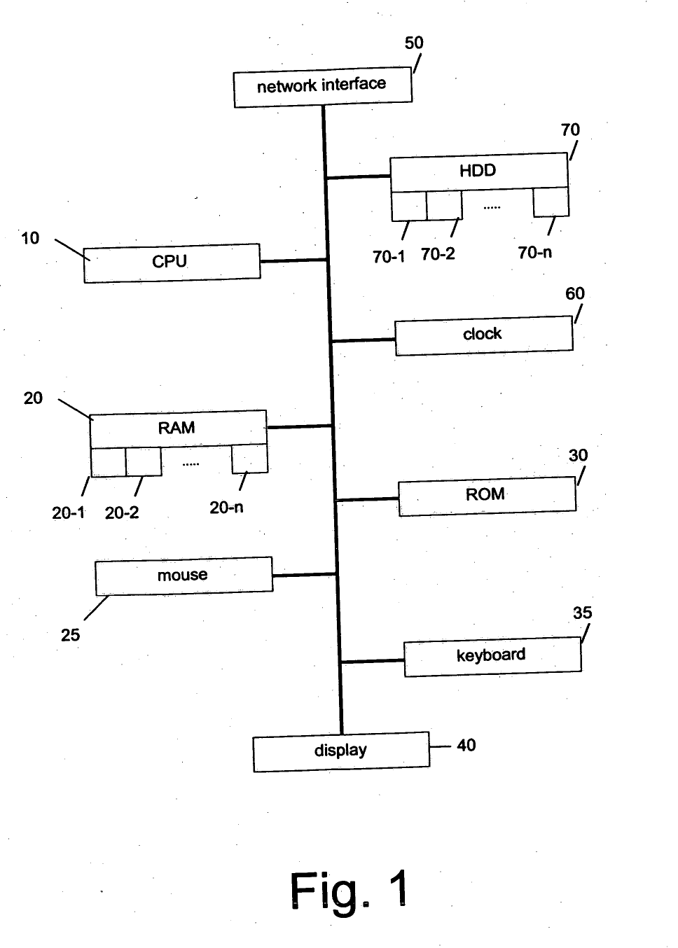

FIG. 1 is a general overview of the hardware components of an electronic trading system of the present invention. The basic processing is performed by a CPU (central processing unit) 10. The system comprises a plurality of storage units, such as a RAM (random access memory) 20, a ROM (read only memory) 30, and a hard disk drive 70. The storage units include a plurality of separate areas, such as RAM-areas 20-1, . . . 20-n and hard disk sections 70-1 . . . 70-n. Various security settings can be applied to the different storage areas, in order to restrict the accessibility of data to particular system users or system components. Thereby, security of confidential data can be achieved, if desired.

The system moreover comprises a clock 60, by which timer functionality can be implemented. Further, the system comprises a plurality of interface components, such as a network interface 50 and a user interface. A user interface comprises components such as a mouse 25, a keyboard 35 and a display 40.

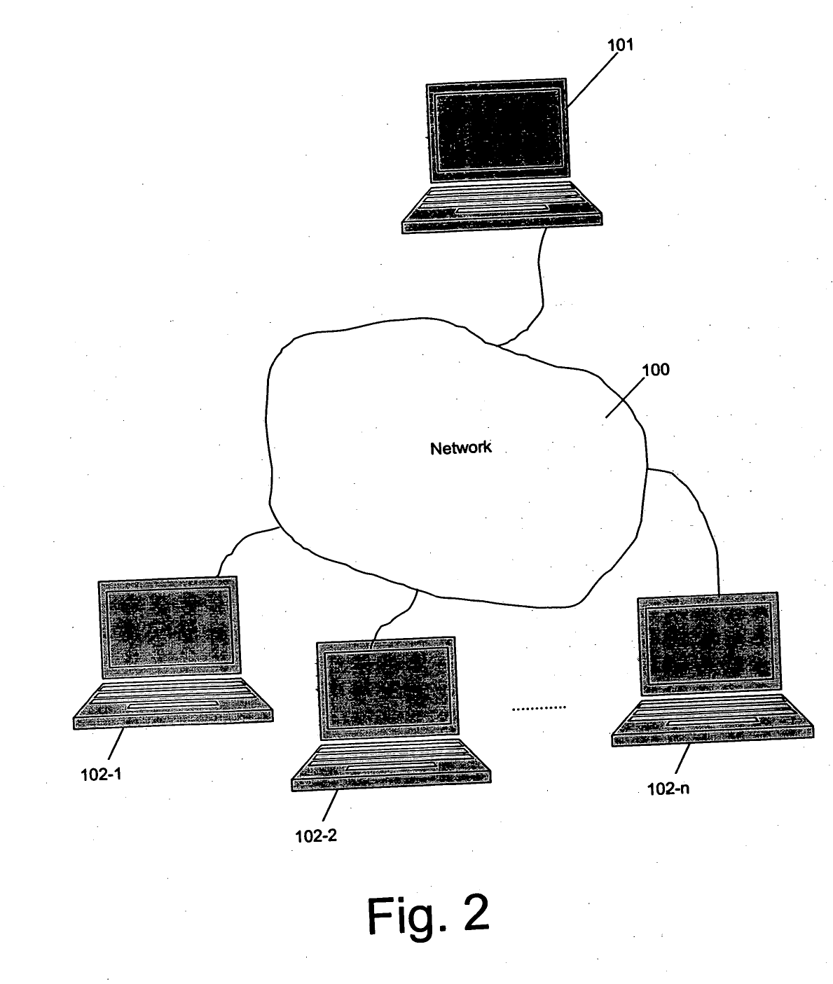

Preferably, an electronic trading system according to the present invention is realized in form of a distributed architecture, including a server and a plurality of clients. An example of the general structure of a distributed electronic trading system is illustrated in FIG. 2. The system comprises a server 101 and a plurality of client terminals 102-1, 102-2 . . . 102-n, which are connected over a network 100. The network 100 can be any conventional computer network such as LAN, WAN, a company's intranet or the internet, without being restricted to the examples mentioned above. Connection links to be established over the network include all desired security requirements. The server 101 performs the central functionality of the electronic trading system, such as block requests and bidder quotes matching processing, evaluating predetermined conditions such as limit price conditions, determining indicative auction prices and terminating auction processes. The peripheral functions, including receiving of requests and quotes, and the various notification functions are distributed over the network interfaces 50 of the server 101 and the terminals 102, as well as the user interface components of the terminals 102.

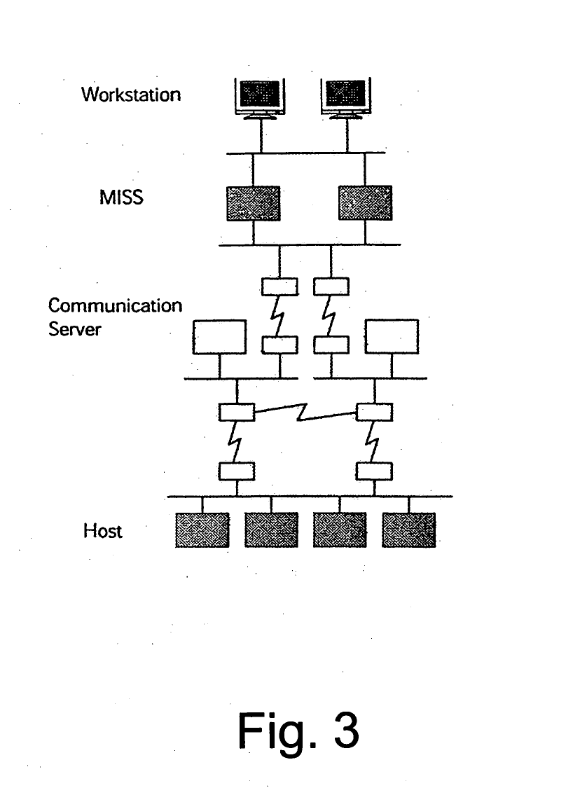

A more specific example of an electronic trading system in accordance with the present invention is illustrated in FIG. 3. The system comprises a front-end part and a back-end part.

The front-end components are installed at the premises of a market participant. The front-end components are preferably realized as a client/server architecture themselves. The front end components comprise a Member Integrated System Server (MISS) and a plurality of workstations. The MISS provides the front end with the necessary applications for a market participant to take part in a block auction according to the present invention. Front end applications include presentation software and interactive functionality. The system client installation available at the workstations give a trader access to the applications provided by the MISS. Alternatively, a reduced front-end configuration, wherein a trader directly communicates with the system over a single MISS, is possible.

Thus, the client/server architecture allows scalability of components, between a minimal configuration, wherein, for example, a trader directly communicates via a MISS with back end systems, and a large configuration, wherein many traders use workstations, that are connected to the back end components via a plurality of MISS.

The back end components of the electronic trading system are installed at the premises of an exchange services providing company. The back end components comprise a plurality of communication servers for establishing a connection between the front end components and the back end components via a network 100, and a plurality of hosts for performing central functionality of the electronic trading system according to the present invention.

The block auction functionality of an electronic trading system in accordance with the present invention enables to replicate OTC-market structures as closely as possible. A block auction request sent to the market by any authorized market participant (by the following called the requester) triggers an anonymous auction, in which any authorized market participant can participate (thereby becoming a bidder).

Unlike standard auction trading, indicative auction prices will be calculated during the auction processing. The indicative auction prices reflect the current market situation, and serve as a basis for a decision of acceptance for execution.

Preferably, separate indicative auction prices will be calculated for the bid and the ask side, regardless of any side information received with the block request. The indicative auction prices, and preferably also the executable volume are visible to the auction participants.

The block auction functionality of the present invention allows an anonymous auction style processing for enabling execution of large orders within the market. Typical order sizes that are currently traded in the off-exchange OTC-market, and which the electronic trading system of the present invention is capable to handle are 1,000 to 5,000 contracts, but very large trades between 10,000 and up to 100,000 contracts are also rather common. The present invention is however not limited to a particular volume.

In principle, parallel auctions may take place for a contract. As the technical prerequisites for parallel auctions are rather complex, in a preferred implementation only a single auction process for a contract is enabled at the same time. Thus, in the preferred implementation in a single series only one auction can be conducted, but the series can be part of different strategies, and for each strategy an auction can be conducted.

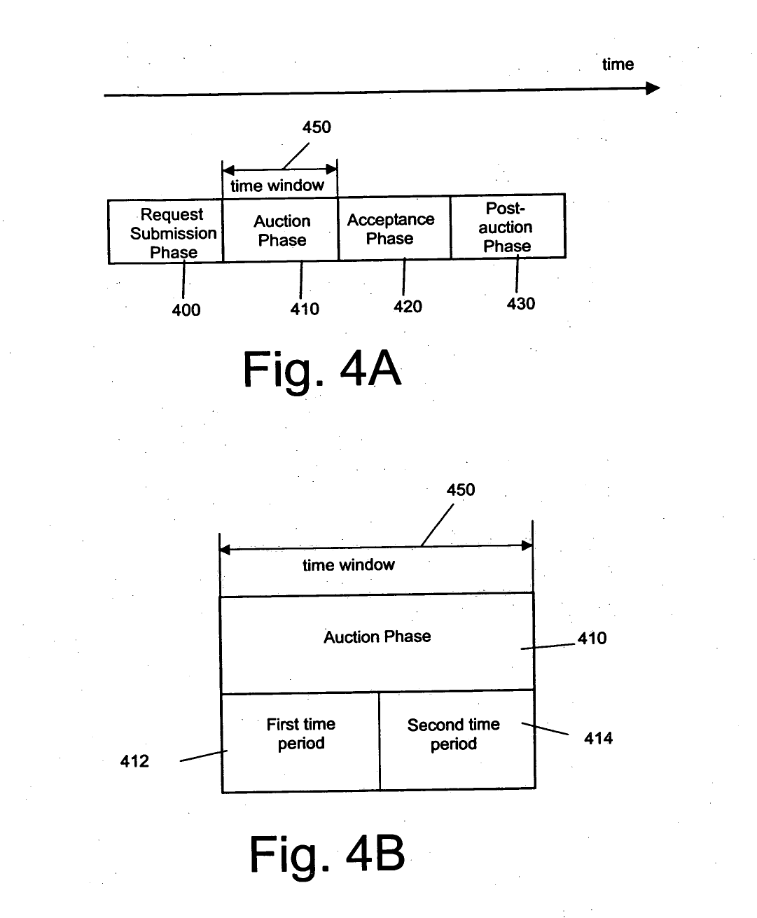

The processing for trading a block request can be divided into four phases. FIG. 4A illustrates the subsequent phases of the block auction of the present invention. The phases are called request submission phase 400, auction phase 410, acceptance phase 420 and post auction phase 430. In the following, the four subsequent phases of the block auction process will be described in more detail with reference to FIG. 4A.

During the request submission phase 400 all authorized members can trigger a block auction by submitting a block request. The request is anonymous, therefore the member ID of the market participant triggering the auction is not published to the market. The triggering of a block auction is public to all authorized market participants.

The block request contains the following mandatory information: Product information, such as an identifier of contracts, futures or strategies to be traded and volume information, for instance the number of contracts requested. Moreover, as an optional parameter, the block requests may contain price limit information and information of the side of the desired trade. The side information is mandatory, if a price limit is entered, and specifies the side of the requested trade, i.e. whether the request is for selling or buying the requested volume of the product. Both optional parameters specifying a price limit and the side of the desired trade are hidden to the market. Therefore these parameters are extracted from the received request information, before block request information is transmitted to the market participants.

Preferably, a minimum contract size specifying a minimum request volume exists. This parameter, called requester minimum size or minimum request volume is preferably larger than the current block trade sizes. The maximum contract size is preferably fixed by the OTC size limits.

In order to increase trustworthiness of an anonymous electronic block auction, the rating per trader indicating the reliability of a requester is displayed with the request. The rating is preferably defined by the percentage of accepted auctions through block requests entered. A long-term and short-term rating will be provided. The method may be improved by exponential smoothing. Exponential smoothing leads to eliminating large fluctuations of the rating information.

As illustrated in more detail in FIG. 4B, auction phase 410 is preferably divided into a first time period 412 and a second time period 414. Second time period 414 is also called “restricted period”.

The auction phase 410 in general, and the first time period 412 in particular, start, when a submitted block request is received at the electronic trading system. Subsequently the block request can be answered by all authorized market participants connected to the electronic trading system. Before a potential bidder has entered any quote, only the rating of the requester and the auction start time can be enquired. The answer has to contain quotes with bid or ask prices. Preferably, only double sided quotes with bid and ask prices are allowed. Moreover, the answer must contain a quote size, which must be set larger than a predefined minimum size (bidder minimum size or minimum quote volume). The bidder minimum size must be set up smaller than the requester minimum size. Preferably, the bidder minimum size is set up from two to ten times, and more preferably roughly five times smaller than the requester minimum size. All answers are treated anonymously, such that the quote data submitted with the answer are not available for any other market participants. By submitting a quote in response to a block request, a market participant becomes an auction participant, and in particular a bidder. The term “auction participant” shall define the requester and the bidders of an auction throughout the present specification. The requester is not allowed to bid on his own auction. Preferably the system automatically validates the identifier of the bidders and rejects bids received from the requester.

An authorized market participant who has got the status of a bidder entering a quote keeps the status of a bidder only as long as he has placed a current quote. The status gets lost after the bidder removes all his quotes.

During the first time period 412, bidders are able to enter, modify or delete their quotes at any time. Preferably, only one auction quote, possibly double-sided, can be entered per bidder at a time. A subsequent quote entered by the same bidder automatically overwrites a quote submitted earlier by the same bidder. All quotes submitted are taken into account in order to find out the matching quotes for the determination of the indicative auction price, and an indicative auction quantity, indicating the currently executable volume.

The indicative auction price is determined by matching the submitted quotes against the volume of the request. As preferably quotes for both trade sides are submitted, separate indicative auction prices are determined, namely an indicative bid price and an indicative ask price. Both indicative bid price and indicative ask price are determined even in the case, if the block request already comprises side information indicating the desired trade side. As the side information of a block trade shall never be communicated to the market, both indicative prices must be always determined, in order to avoid giving a hint towards the intended side of the trade.

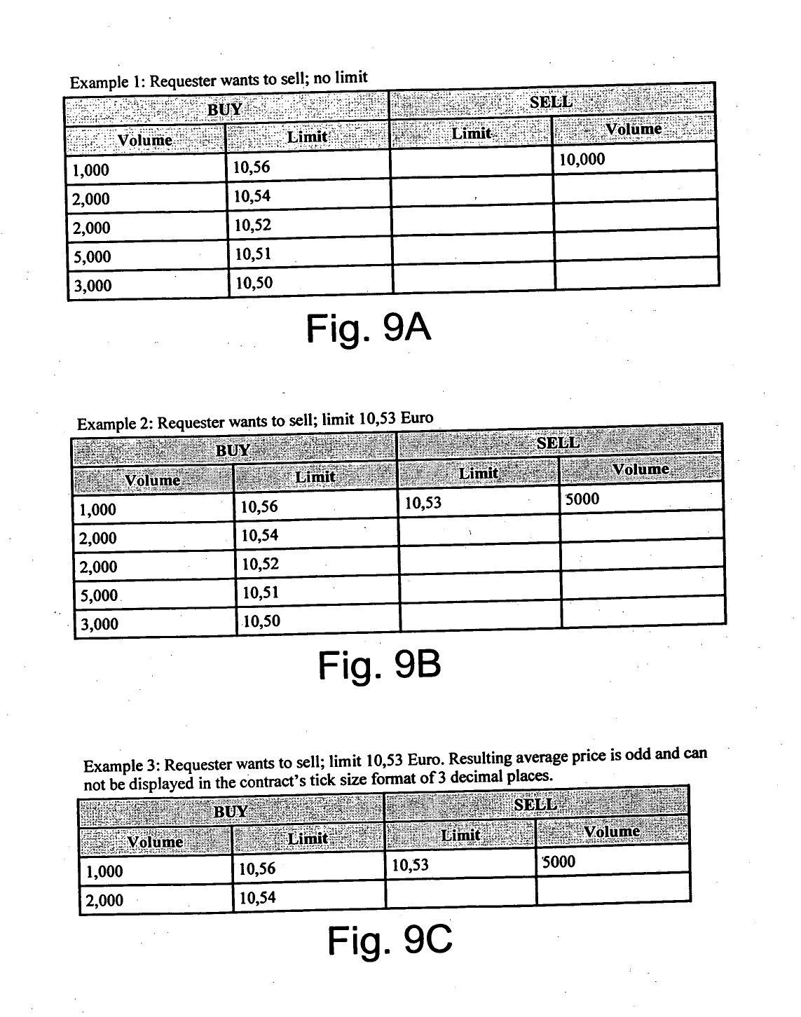

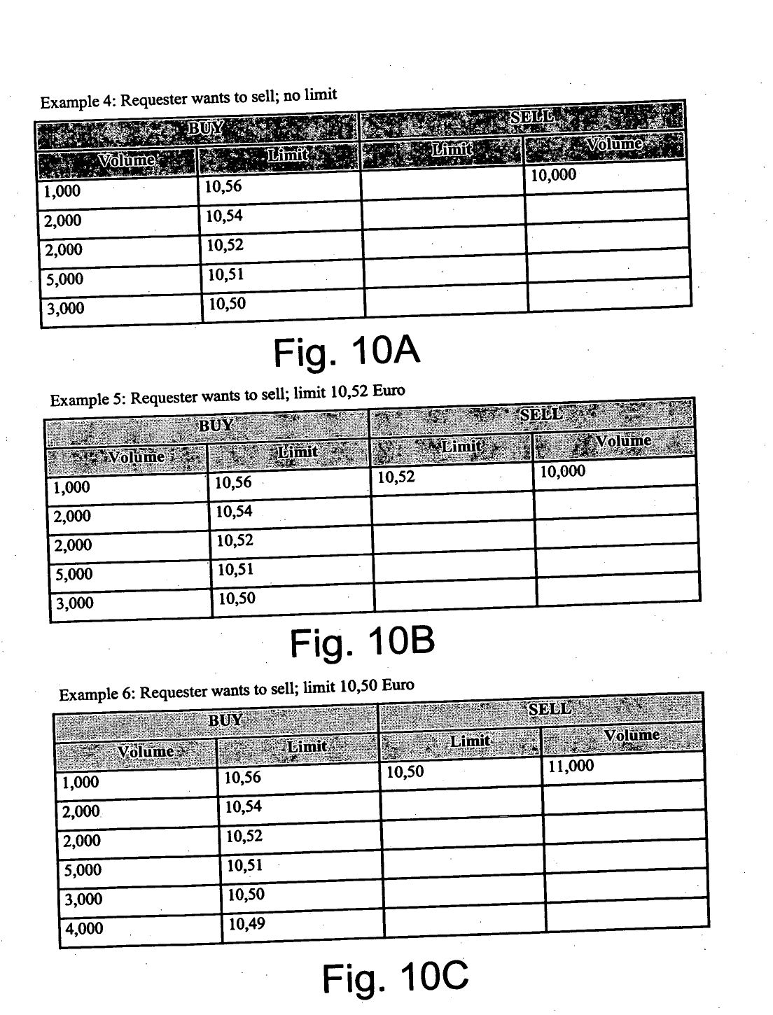

The indicative bid price is determined by matching all currently submitted bid quotes against the volume of the block request. Accordingly, the indicative bid price is determined, as if the requester would intend to sell the request volume. On the other hand the indicative ask price is determined by matching all submitted ask quotes against the request volume. Thus the indicative ask price is determined, as if the requester would intend to buy the request volume. Detailed illustrative examples of determining the indicative prices will be described below in connection with FIGS. 9 and 10.

The indicative prices and executable volumes are displayed to the participants of the auction. Bidders also receive a permanent update, whether their quotes are marketable. Marketability of a quote means that the quote would be executed against the block request, if the block request would be accepted for execution at this moment on the basis of the prevailing indicated price for the respective side of the quote. Preferably, the marketability information also includes information about the executable volumes, to account for the situations, wherein the quote is only partially executable.

The indicated marketability is determined independently of a predefined limit price of the requester, if such limit price has been specified. Moreover, also the marketability information is generated and transmitted to the bidders for both sides, even if a side parameter has been specified in the request. Thereby no hint is given to the market regarding the desired side of the block request. This is particularly advantageous, having in mind the large volume of a block request. A large order would have a great influence on the market, if the side would be known. For instance, a bidder with an aggressive two-sided quote may receive the information that the quote is marketable for the buy side (referring to the indicative bid price), and for the sell side (referring to the indicative ask price) at the same time.

The first time period ends with the acceptance of the auction for execution (either automatically or manually) or after a predefined time has elapsed. Acceptance of the auction for execution is possible at every point of time during the first time period.

The second time period (restricted period) 414 follows immediately after the first time period 412, if the auction has not been accepted for execution during the first time period 412 and any bidder exists at the end of the first time period 412 (i.e. any market participant has placed a current quote).

Only those market participants having placed a current quote at the end of the first time period 412 are allowed to participate in the restricted period 414. No other market participants are able to submit new quotes. Such quotes would be automatically rejected by the system. As outlined above, every market participant who has entered a current quote during the first time period 412 is by definition a bidder. A bidder loses the bidder status and consequently the right to enter quotes during the restricted phase 414, if he has removed his quotes during the first time period 414.

In the restricted period 414 bidder actions are limited. In particular, a bidder is no more allowed to delete his quotes during the restricted period 414. Accordingly, bidders are forced to enter serious quotes representing a serious demand for trading. Moreover, quote modification of a bidder is limited to the improvement of their quotes during the restricted period 414. Improvement of a quote means price improvement and/or quantity improvement. Price improvement is defined by a spread that is equal to or smaller than the current spread. The spread is defined as the difference between the current bid and ask price. Quantity improvement of a quote means equal or greater volume.

As in the first time period 412, the indicative prices and executable volumes are displayed to the participants of the auction during the restricted period 414. Moreover, bidders receive a permanent update of their marketability information as well. The restricted period 414 ends with the acceptance of the auction for execution or latest after a predefined time has elapsed. Acceptance of the auction for execution (either automatically or manually) is possible at every point of time during the restricted period.

The maximum length of the auction phase (i.e. length of the auction phase in the case if the auction is not accepted) is controlled by a timer. The timer defines time window 450 as the maximum period of the auction phase. Preferably, separate timers are provided for counting the first time period 412, and the second time period 414.

Preferably, the duration of the time window 450 can be automatically adjusted dependent on the request volume. In a particular preferred embodiment, therefore, the parameter ALQD (auction length quantity discriminator) is introduced and validated against the request volume. If the request volume is less than parameter ALQD, a predefined shorter duration of the first and second time periods applies. If the request volume is larger than or equal to the parameter ALQD, a predefined longer duration of the first and the second time periods applies. Therefore in the described embodiment four timers will be implemented per product, determining the maximum duration of the first and second time periods, either for short or long auctions. The four timers define the maximum duration of the first time period 412 for the short and long case, respectively, and the maximum duration of the restricted period for the short and long case, respectively. The adjustment of the duration of the auction phase is however not limited to the exemplary procedure outlined above. Alternatively, for instance, also a continuous dependence of the duration upon the request volume may be implemented.

The initiation of the auction, the transition between the first and the second time periods, and the end of the auction can be accompanied by an acoustic signal. As described above, the length of the auction phase is preferably defined per product, and the length of the auction phase 410 depends on the request volume. The unit for defining the time is preferably seconds.

The acceptance phase 420 starts immediately after the block auction has been accepted for execution. During the acceptance phase the following processes are performed: Execution, determination of the final auction price and partitioning of the block trade volume among the participants who are successful to participate in the trade.

Full or partial execution takes place if the auction has been accepted for execution during the auction phase 410. If the trade has not been accepted during the auction phase 410, no execution takes place. Then the request and all quotes are deleted and the auction is closed without execution. Alternatively an uncrossing of the quotes against each other can be implemented. Examples of schemes for determining the auction price and partitioning the volume of the block trade are described in detail below with reference to FIGS. 9, 10 and 11.

In the final post auction phase 430, after the execution of the trade, the following processes are started:

Display of executed volume and trade price (unless trade is subject to non disclosure of block trades according to specific legal restrictions)

Trade confirmations are sent to the buyers and sellers.

Under certain circumstances, uncrossing of a crossed order book comprising quotes that have not been executed during the block auction.

Initiation of the clearing of the block auction trade.

As the processing of the post auction phase is not part of the present invention, a detailed description thereof is omitted herein.

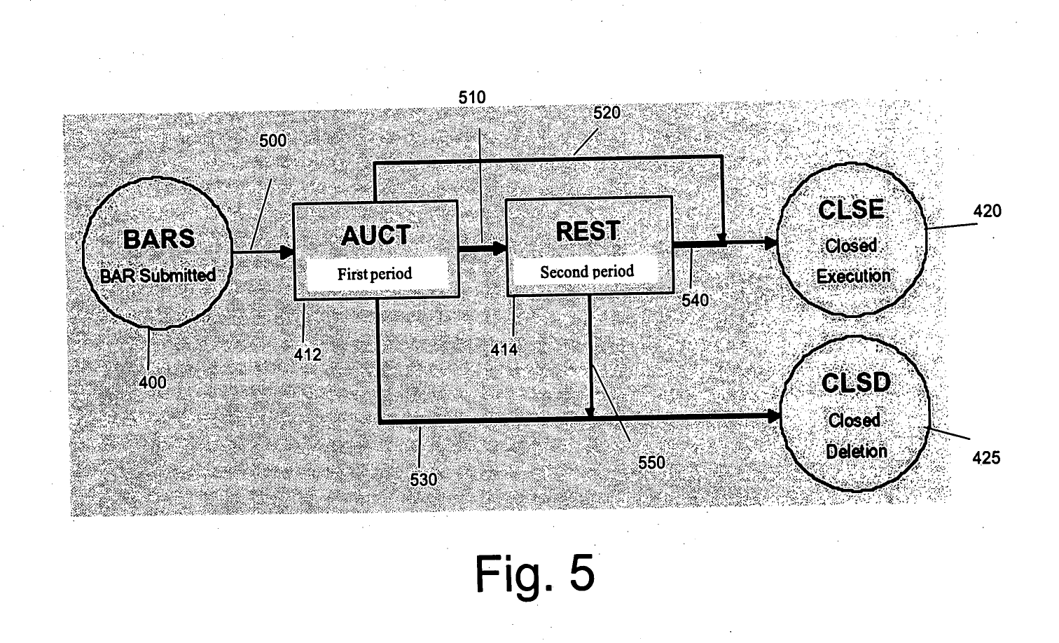

Possible transitions between the phases of the block auction according to the present invention are now described with reference to FIG. 5. Arrows indicate the different possible transitions. Arrow 500 illustrates the transition between the request submission phase 400 and the first period 412 of the auction phase 410. A transition occurs right after the request has been entered.

Arrow 510 illustrates the transition between the first period 412 and the second (restricted) period 414 of the auction phase 410. This state transition is automatically performed, after a predefined time of the first period has elapsed without acceptance. Thus, this time frame specifies the maximum duration of the first period of the auction phase in seconds.

Transition arrow 520 indicates the transition from the first period of the auction phase directly to the acceptance phase 420. The transition occurs in case the auction has been accepted for execution during the first period of the auction phase 410.

Transition arrow 530 illustrates the transition from the first period of the auction phase to a closed state 425 without execution. The transition occurs in case the auction has been cancelled during the first period 412 of the auction phase 410, for instance if the request has been deleted. In this case the block auction never reaches the acceptance phase 420.

Transition 540 between the restricted period 414 and the acceptance phase 420 occurs, if the auction has been accepted during the restricted period 414.

Finally, the auction state may switch from the restricted period 414 to the closed state 425 without execution. Corresponding transition 550 occurs if the auction has been cancelled during the restrictive period 414. The transition also occurs in case the time duration of the restrictive period 414 has elapsed without acceptance.

If no quote has been entered during the first period 412 at all (no formal bidder exists), the system switches immediately from the first period 412 via the second period 414 and transition path 550 to the closed state without execution 425, without awaiting the duration of the restricted period.

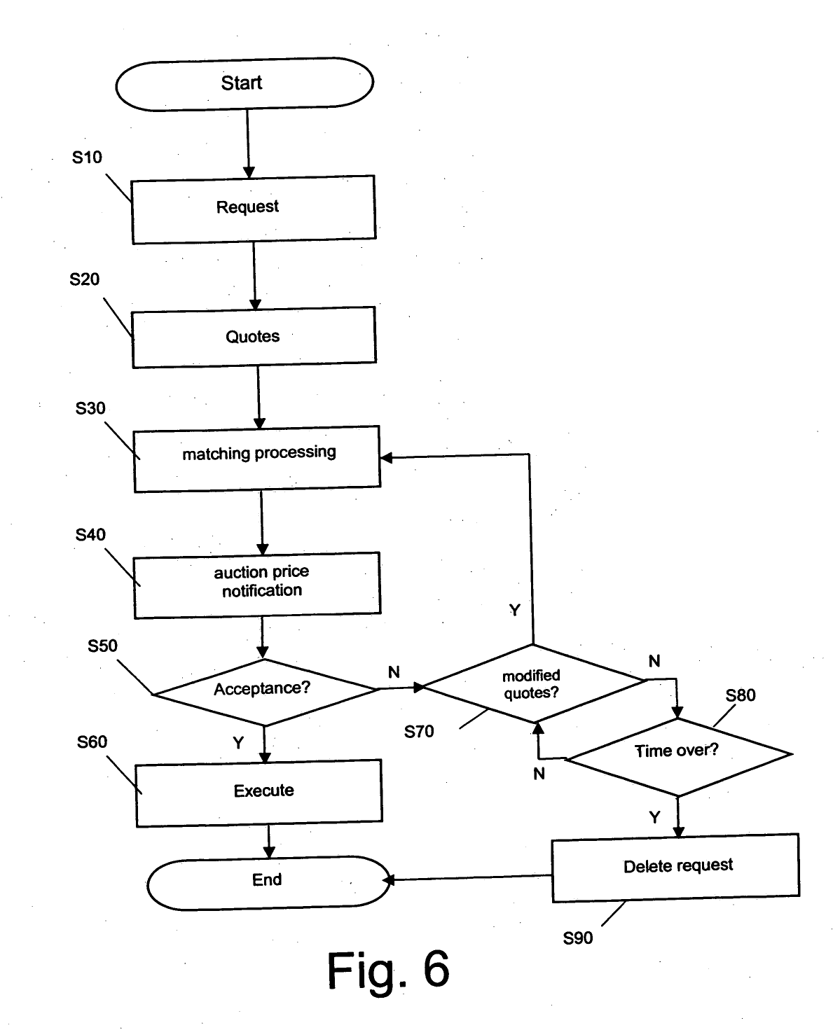

In the following, the general processing of a block auction in accordance with the present invention will be described with reference to the flow chart of FIG. 6.

At step S10, the electronic trading system receives the block request that triggers a block auction in accordance with the present invention. According to the preferred embodiment, a requester is allowed to enter one order per auction, which can be modified. It is noted that the term “requester” is not restricted to a natural person, but shall be defined on trader level. The term “requester” includes, for instance, subgroups of members representing an organisation, which has subscribed to the electronic trading system.

As already briefly outlined above, a block request can be a non-specified order, or a so called trigger order. A non-specified order comprises only volume information, but does not specify any price and side information. In case of a block request being a non-specified order, side information must be specified later.

A trigger order specifies a limit price condition and side information together with the request volume. Additionally, in a trigger order also a limit volume (also called “trigger volume”) can be specified. The limit volume has to be set smaller than the request volume. In principle, a trigger order does not require further interaction of a requester, who therefore may leave the block auction unattended, if automatic acceptance is permitted, when the complete request volume is executable on the basis of an indicative auction price fulfilling the price limit condition. In case a trigger order comprises a limit volume, automatic acceptance will be permitted when the limit volume is executable on the basis of an indicative auction price fulfilling the price limit condition.

It is however noted that the possibility to specify a limit price is not limited to trigger orders. In a particular embodiment, a limit price may also be set as an additional parameter in a non-specified order.

Although preferably an indicative auction price is determined by matching the complete volume of a block request with the volumes and prices of the quotes, the invention is not limited to this case. Alternatively, also a part of the request volume can be matched with quotes for determining an indicative auction price. For instance, if a block request comprises a limit volume being a part of the request volume, the quotes can be matched with the limit volume for determining an indicative auction price.

Indicating a limit volume which is kept anonymous to the market in a block request serves as a further means in order to provide a more flexible auction process with minimal market influence.

In order to be able to respond to the block request by entering quotes, the authorized market participants must receive an information about the block request received by the system. Preferably, this is achieved by sending out a notification to the terminals of the authorized market participants. Alternatively, for instance, information about the volume of a received block request can be made accessible for enquiry by authorized users directly at the central part of the system. A person skilled in the art is aware that there is a plurality of solutions to inform a market participant in electronic trading, including for example e-mail, and the present invention is not limited to the above examples.

During subsequent step S20, in response to the block request, a plurality of quotes are received by the system. The quotes are submitted from market participants, who thereby receive the status of bidders. As the term “requester”, also the term “bidder” is not restricted to a natural person, but shall be defined on a member of subgroup level. Preferably, only one quote per subgroup is allowed, wherein subsequent quotes override existing ones. Preferably, only double sided quotes are allowed that unify a bid quote and an ask quote for the block request. Double sided quotes are in particular compliance with the approach of the present invention, wherein bidders do not receive any side information of the block request, in order not to influence the market.

In subsequent step S30, the received quotes are matched against the volume of the block request. As outlined above the matching is performed separately for both of the two sides, i.e. ask quotes and bid quotes, thereby determining an indicative bid price and an indicative ask price. Details of the matching processing for determining the indicative auction prices are explained below in connection with FIGS. 9 and 10. Subsequently, the auction participants receive an information about the determined indicative bid and ask prices (S40). Moreover, preferably the individual bidders receive marketability information of their quotes at the same time.

Subsequent step S50 illustrates the acceptance of the block auction for execution. As outlined above, acceptance is possible at every point of time during the auction phase 410, either automatically, or manually, by an interaction of the requester. The indicative auction price serves as a basis for the acceptance decision. If the block request is a trigger order, wherein the limit price has been specified together with the side of the trade, the acceptance can take place without any further interaction. The block auction is then automatically accepted for execution, if the entire request volume or a trigger volume specified in the block request can be executed at the specified limit price or better (wherein it depends on the trade side, if the better price is lower or higher that the price limit). However, the requester has also the possibility to modify the limit price and the limit volume, if applicable during the auction phase 410.

According to a further exemplary acceptance procedure called interactive acceptance in the following, the auction can be accepted for execution by entering a price and determining the side of the trade during the auction phase 410. Interactive acceptance is possible for block request of those non-specified order type and trigger order type. In case of a trigger order block request, the parameters entered upon interactive acceptance overwrite the predefined parameter values. In case of the interactive acceptance, the request is executed up to the request volume or limit volume previously defined, or is only partially executed at the maximum available volume at the specified price, if no complete execution at this price is possible. In case of a price change between notification (S40) and acceptance (S50), such that the execution at the entered price is impossible, the acceptance is rejected with a message such as “executable price changed—accept was rejected”.

Unlike the limit price, the request volume cannot be adjusted during the auction. Only in case the requester enters a certain price to accept the auction, the request volume is replaced by the current maximum available volume, which may be smaller than the request volume, if the block request is only partly executable at the specified price, since only a part of the request volume can be matched against quotes on the basis of the entered price.

In the following, two illustrative embodiments of interactive acceptance of the block auction will be described.

According to the first example, the requester can accept by specifying one of the indicative auction prices upon a simple operation, such as a mouse click. In case the indicative bid price is specified, the side is automatically specified as selling, and the auction is accepted for execution based on the matching quotes underlying the indicative bid price. If the indicative ask price has been specified for acceptance, the side is automatically specified as buying, and the auction is accepted for execution on the basis of the matching quotes underlying the indicative ask price.

According to a second exemplary interactive procedure of acceptance, a price can be entered which deviates from any of the current indicative auction price. In this case, the requester must therefore define the side of the request as buy or sell, for instance by pressing a respective buy/sell toggle button provided by the user interface. Accordingly, the block auction will be accepted for execution by determining the maximal volume of the request that can be matched against existing quotes of the specified side, on the basis of the specified price. In case of accepting the auction by entering a price that deviates from the current indicative auction prices, the requester can only improve the indicative auction prices. Accordingly, a price entered at acceptance has to be better than the respective indicative auction price for the specified side of the trade. Depending on the side of the trade, this means: price specified at acceptance must be larger than the indicated bid price if the request is specified for selling, and the price entered for acceptance is must be smaller than the indicative ask price, if the request is specified for buying.

After execution of the block auction has been accepted in step S50, the processing flow succeeds to step S60 for trade execution. Thereby, the auction processing is terminated. As long as the block auction has not yet been accepted for execution, submission of modified quotes is possible during the predetermined time window 450. Submission of modified quotes is illustrated by step S70 in FIG. 6. Although not shown in the exemplary drawing, it is noted that deletion of quotes as well as submission of new quotes is accepted as well, during the first time period 412 of the auction phase 410. Submission of modified quotes at step S70 (as well as deletion of quotes or submission of new quotes) leads to a change of the existing quote situation. Therefore, if the existing plurality of quotes has been modified, the processing switches back to the matching step S30, for updating the indicative auction prices. A corresponding processing flow is indicated by the transition arrow from step S70 to step S30.

The procedure of modifying quotes, matching and notifying of updated indicative auction prices is iteratively repeated, as long as the block auction has not been accepted for execution, and the predefined time of time window 450 has not elapsed. The flow of the iteration is illustrated in FIG. 6 by the cyclic processing S70 (Y)→S30→S40→S50 (N). (In FIG. 6 and the subsequent flowcharts, “yes” is abbreviated by Y, and “no” is abbreviated by N.) The time window is permanently watched, as indicated by step S80. As long as the predefined time has not elapsed, further quote modifications are possible. This possibility is indicated by the transition S80 (N)→S70. As soon as the predefined time window 450 is over, and the execution has not been accepted, the flow switches from S80 to step S90. At step S90 the auction is terminated without execution, and the request is deleted.

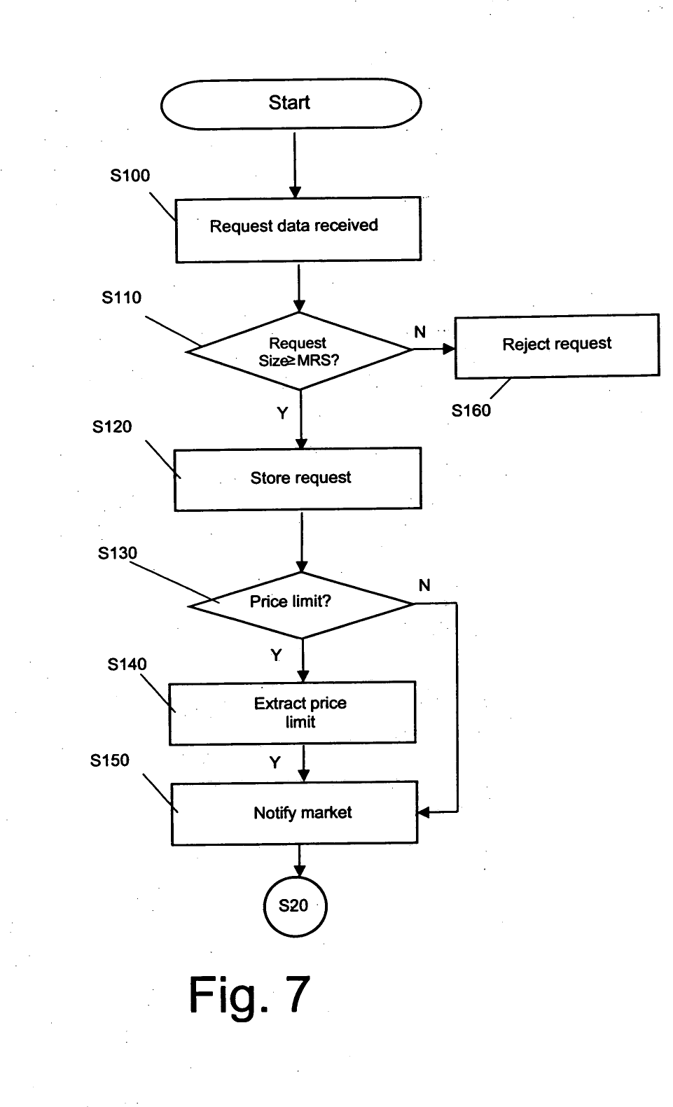

In the following, the processing is performed during the block request submission phase 400 is described in more detail referring to FIG. 7.

The electronic trading system receives the data of the request at step S100. As outlined above the request data may correspond to a trigger order, wherein the price limit and side information have been specified together with the request volume and possibly a trigger volume. Alternatively, the request data may correspond to a non-specified order, indicating only the request volume and possibly a trigger volume without price limit and side specification.

At subsequent step S110 it is determined whether the request volume is larger than or equal to a predefined minimum requester size (MRS). As described above, the MRS is the minimum request volume allowed to be entered with a block request. If the request volume is smaller than predetermined parameter MRS, the flow proceeds to step S160, rejecting the request. Preferably, the requester receives a notification from the system, such as “quantity must be greater than minimum requester size”, for quantities lower than the product minimum requester size entered by the requester. If the requested volume is larger or equal to MRS, the flow proceeds from S110 to step S120.

At S120, the received request data are stored in the system memory. Subsequently, the system judges, whether the request comprises a price limit condition, at step S130. As described above, a block request comprising a price limit condition must always comprise side information as well. If it is judged at step S130, that the block request comprises price limit and side information, processing switches to step S140, wherein the price limit condition is extracted and stored in a restricted memory area, which is not accessible from outside. If a block request further comprises a limit volume, also the limit volume has to be extracted and stored in a restricted memory area. Extraction of price limit condition, side information and limit volume is necessary to be performed before notification of the market participants, as price limit, side information and limit volume have to be kept anonymous for performing a block auction in accordance with the present invention. Since a block auction comprises large volumes, publication of price limit, side information and limit volume would certainly influence the market to an extent that would render performing the block auction impossible.

After price limit and side information have been extracted from the request data at step S140, the flow proceeds to step S150, wherein the market participants are notified of the block request. If it is judged as step S130, that the block request does not comprise price limit information, the flow switches directly from S130 to step S150, and the market participants are notified of the block request. Subsequently, submission of quotes in response to the block request is possible as indicated by the transmission from step S150 to step S20 at the bottom of FIG. 7.

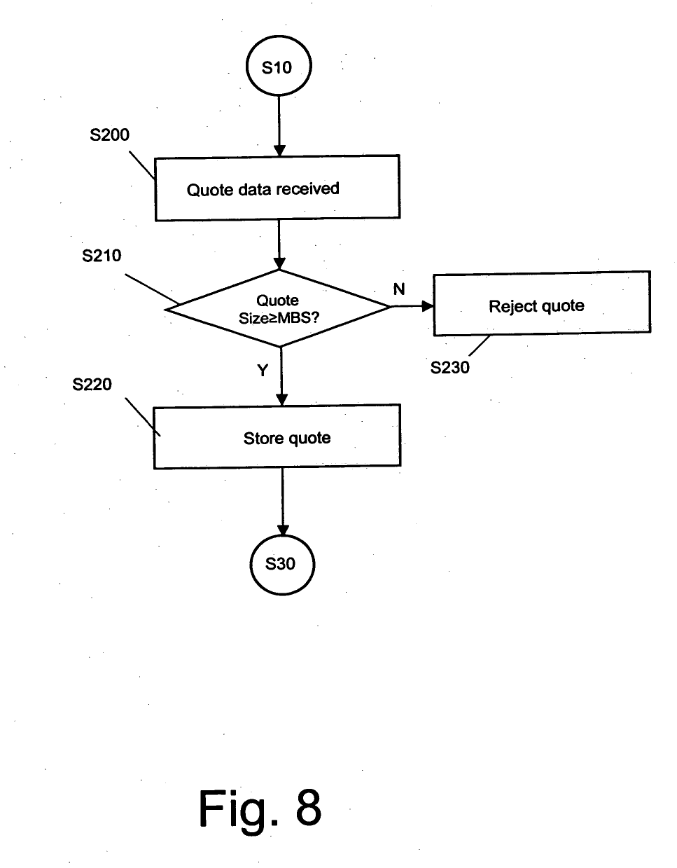

A more detailed explanation of the processing of step S20 will now be given with reference to FIG. 8. At the initial step S200, quote data are received. Subsequently, at step 210 the system judges whether the quote volume is larger or equal than a predetermined minimum bidder size (MBS), also called minimum quote volume. MBS is the minimum quote size for a bidder. If the volume of the quote received is smaller than MBS, the processing switches from S210 to step S230. At S230, a received quote is rejected. Preferably, a bidder is notified of the rejection of the quote by a message such as “quantity must be greater than minimum bidder size”, if the bidder enters a quantity lower than the product minimum bidder size MBS.

On the other hand, if the received quote volume fulfils the condition to be larger than or equal to MBS, processing switches from S210 step S220, and the received quote data is stored. Subsequently, processing switches to S30, for further processing the quote data for matching against the request volume and determining an indicated auction price.

It is noted, that a similar judging processing is also applied for received modified quotes, at step S70 in FIG. 6, and is not restricted to newly submitted quotes at S20. It is moreover noted that a similar rejection procedure also applies for other conditions that have to be fulfilled in particular embodiments of the invention. For instance, if only double sided quotes comprising an ask and a bid quote in a single quote are allowed, all single sided quotes submitted will be rejected upon reception by the system.

In the following, examples for determining indicative auction prices by matching received quotes against a block request will be described with reference to FIGS. 9 and 10.

Generally, the indicative auction prices (indicative bid price and indicative ask price) are always calculated as if executed against a market order of the requester (i.e. a request that does not specify price information), even if the requester has entered a limit price. The definition of the indicative prices is analogous to the auction price determined and used as a basis of the volume distribution over plural successful bidders for execution, after acceptance. Both procedures differ only in that the final auction price takes into account the price limit (either already specified in the request, or specified later, latest upon acceptance), while the indicative prices are calculated as if executed against the market order without taking into account any limit price.

By way of example in the following determination of auction prices will be described on the basis of volume weighted average prices and volume clearing prices. It is however noted, that algorithms for determining an auction price are not limited to these models, but other suitable models can be employed as well for implementing the invention. As indicated above, although in the following examples the determination of the indicative auction prices is described on the basis of matching received quotes against the complete request volume, only a part of the request volume, for instance a trigger volume included in the block request, may be also employed therefore.

### Volume Weighted Average Price

For determining the volume weighted average price (VWAP), the volume weighted average of the prices of all matching orders is calculated according to the formula

$$P = {\sum }_{n = 1}^{N} \frac{{V}_{n} \cdot {p}_{n}}{N} ,$$

wherein P is the volume weighted average price and n is the current number of a quote, N is the total number of matching quotes of the respective side, Vₙ is the volume of the quote, and pₙ is the price to be specified in the quote. The calculated volume weighted average price corresponds to the average price received by the requester in case of execution, but the execution for the bidders is done for each limit until the whole volume is reached. In particular, it may happen that no individual bidder will be executed at the volume weighted average price.

Request and quote data of a first calculation example are given in FIG. 9A. The block request specified in FIG. 9A for a volume of 10,000 contracts does not comprise price limit information. In this example, as well as in the following examples, it is assumed for simplicity that the block request is a request for selling, and therefore only bid quotes have to be taken into account for the matching and price determination procedure. It is however to be noted that in according to the described embodiment of the present invention, no side information is available to the market, and therefore indicative bid price and indicative ask price have to be determined separately for the block request.

In the example of FIG. 9A, five bid quotes are available. In the tables of FIG. 9A and the following figures, the quotes are generally given in an ordered list according to their quote prices, beginning with the quote having the best price. If two quotes with the same quote price are available, the quote received first in time is listed first.

For the calculation of the volume weighted average price only the best quotes are taken in to account, until the request volume of 10,000 contracts is filled. Therefore, only the first four quotes in the table are taken into account (N=4). The last quote is not taken into account, as it does not match with the request volume of 10,000 contracts. According to the formula given above, the indicative auction price is calculated as P=10.523 [symbol] . It is noted that a situation may occur, wherein only a part of the quote volume of the last quote (n=N) is required to fill the request volume. In this case, only the respective part of the quote volume is taken into account for determining the VWAP, i.e. V_{N} equals the part of the volume of quote N that is required to fill the request volume.

Although the explanation is given on the basis of the currency unit Euro herein by way of example, it is to be noted that the present invention is not limited to Euro trades, but any other currency can be used with the same effect, for instance US-Dollar, Canadian Dollar, or Japanese Yen.

In the case of execution on the basis of the calculated indicative bid price of 10.523 [symbol] , the bidders would be executed as follows: 1,000 contracts at 10.56 [symbol] , 2,000 contracts at 10.54 [symbol] , 3,000 contracts at 10.52 [symbol] , and 5,000 contracts at 10.51 [symbol] .

The second example of determining an auction price on the basis of volume weighted average price is described with respect to the data of FIG. 9B. The exemplary data given differ from the data of the first example only with respect to the block request data, while the quote data are maintained the same as in FIG. 9A. In FIG. 9B, the request volume is only 5,000 contracts instead of 10,000 contracts, while the request comprises a price limit of 10.53 [symbol] . Accordingly, only the first three quotes in the table match with the block request (N=3), which results in an indicative bid price of 10.536 [symbol] . In case of an execution on the basis of the calculated indicative bid price, 1,000 contracts would be sold at 10.56 [symbol] , 2,000 contracts at 10.54 [symbol] , and 2,000 contracts at 10.52 [symbol] . As can be seen from the example, partial execution at a price below the requester's sell limit is possible, as long as the average price limit for the total volume is not violated.

FIG. 9C illustrates exemplary data, wherein only a partial execution is possible. While the block request data correspond to the data of FIG. 9B, in the example of FIG. 9C only two bid quotes are available. As the total volume of the two bid quotes is only 3,000 contracts, the block request is matched only partially. As both quotes can be matched with a part of the block request volume, N=2 in this case. The indicative bid price therefore amounts to 10.54666666667 [symbol] . In an execution performed on the basis of this indicative auction price, theoretically 1,000 contracts would be sold at 10.56 [symbol] , and 2,000 contracts at 10.54 [symbol] . According to a preferred embodiment, the “contract tick size format” comprises three decimal places. As the resulting volume weighted average price does not fit into three decimal places, the auction price would be rounded to the bidder's favour in case of execution. The rounded value of the auction price would be 10.546 [symbol] . The remaining 2,000 ticks would be distributed over the top 2,000 contracts of the bidder's quotes resulting the first quote being executed at 10.559 [symbol] for its entire size of 1,000 contracts, and the second quote being executed at 10.539 [symbol] for 1,000 contracts and 10.54 [symbol] for the remaining 1,000 contracts. The resulting executions will exactly yield the average price of 10.546 [symbol] . However, the present invention is not limited to the exemplary tick size format described above.

### Volume Clearing Price

Alternatively, an algorithm called “volume clearing price” can be employed for determining the indicative auction price. According to the volume clearing price algorithm, the indicative auction price is determined by the price of the worst offer of a bidder, which would fill the block request.

FIG. 10A shows an example of data, which corresponds to the data of FIG. 9A. However, in the case of the volume clearing price algorithm, the indicative bid price would be 10.51 [symbol] , i.e. the price of the second last bid quote in the table. The second last bid quote in the table is the cheapest quote required to fill the request volume of 10,000 contracts.

The example of FIG. 10B differs from FIG. 10A only in that the block request of FIG. 10B comprises a limit price of 10.52 [symbol] . As an indicative auction price is determined independent of the predetermined limit, the indicative auction price would amount to 10.51 [symbol] , as in the case of FIG. 10A. If however, the auction would be accepted for execution at the specified price limit of 10.52 [symbol] , only partial execution of 5,000 contracts would be possible, as bidders below 10.52 [symbol] would not be executed. The respective volume clearing price for execution would therefore be 10.52 [symbol] in the case of FIG. 10B.

In the example of FIG. 10C, the request volume of 11,000 contracts is to be sold with the limit price of 10.50 [symbol] . Six bid quotes are available, wherein the total volume of the bid quotes is 17,000 contracts. The order with the cheapest price required to fill in the request volume of 11,000 contracts is the second last order in the table. Therefore, the indicative bid price is determined as 10.50 [symbol] . As price limit of 10.50 [symbol] does not exceed the indicative bid price, the request volume could be completely executed at the price of 10.50 [symbol] . In case of acceptance, the request would be executed against five bidder quotes, namely 1,000 contracts at 10.56 [symbol] , 2,000 contracts at 10.54 [symbol] , 2,000 contracts at 10.52 [symbol] , 5,000 contracts at 10.51 [symbol] and 1,000 contracts at 10.50 [symbol] .

10.50 [symbol] is the last order filling up the requested quantity of 11,000 contracts, and thus determines the trade price. The last order filling up the requested quantity comprises 3,000 contracts, and therefore will be only partially executed at a volume of 1,000 contracts.

In the case of FIG. 10D, the block request corresponds to the block request of FIG. 10C. However, the order book comprises only bid quotes with a total volume of 5,000 contracts. Accordingly, volume of the block request can be only partially matched against the bid quotes. As the worst of the matching bid quotes has the price of 10.52 [symbol] , an indicative bid price of 10.52 [symbol] will be displayed. In case of acceptance of the auction at this price, the block request would be partially executed against three bidder orders, namely 1,000 contracts at 10.56 [symbol] , 2,000 contracts at 10.54 [symbol] , and 2,000 contracts at 10.52 [symbol] , wherein the last order determining the maximum available quantity of 5,000 contracts determines the trade price of 10.52 [symbol] .

The matching algorithm and price determination procedure employing the volume clearing price can also be alternatively described as follows:

The block request is matched against the quotes of the bidders. The price of the last bidder's quote fulfilling the request volume would be the decisive match price for the entire trade according the principle of maximising executions. Thus, advantage is always given to the requester. Volume clearing price can be alternatively defined as a price fulfilling the following four criteria:

Principle of maximizing executions: the volume clearing price is a price for which the tradable volume is maximized.

Principle of the existing limit price: the volume clearing price can only be a limit price of an existing quote in the order.

Principle of price continuity: the remaining best ask price resulting from the execution of a trade, i.e. the best of those that are not good enough to be successful in participating in the trade, is always higher than or equal to the trade price, and the remaining best bid price resulting from the execution of a trade is always lower than or equal to the volume clearing price.

Principle of inflation: the volume clearing price is the highest price of all prices fulfilling the first three criteria.

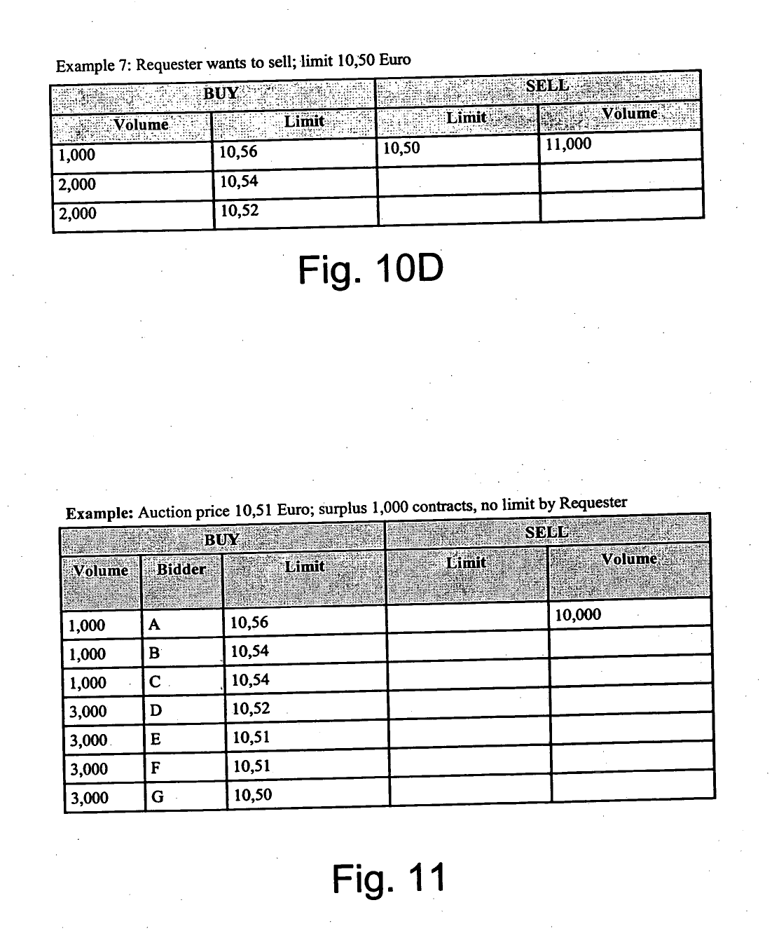

The processing for partitioning of the block auction volume will now be described in more detail by way of example referring to the table of FIG. 11. A block request for selling with a request volume of 10,000 contracts is to be executed against seven bid quotes. Assuming that the volume clearing price is used to determine the auction price, the auction price will be 10.51 [symbol] . The first four bid quotes in the table having prices exceeding the auction price, have a total volume of 6,000 contracts. Therefore 4,000 contracts are left after full execution of the first four bidders. The following two bid quotes of bidders E and F, corresponding to the auction price of 10.51 [symbol] , have a total amount of 6,000 contracts (3,000 contracts of E and 3,000 contracts of F). As only a part of the volume of bidders E and F matches with the request volume, and the bid price of both bidders is the same, time priority takes effect. As the quote of bidder E has been received earlier, 3,000 contracts of E will be executed because of time prioritization, and only 1,000 contracts of bidder F would be executed at the price of 10.51 [symbol] .

Summarizing, partitioning of block auction volume on the bidder side follows price/time priority: the bidders with the best prices get full execution until the block volume is reached (price priority). If more than one bidder is to be executed at the same price level, time priority counts.

The foregoing detailed description is illustrative of the principles of the present invention by way of example only. The person skilled in the art will be aware of numerous changes and modifications and it is not desired to limit the invention to the exact construction and operation shown and described. Accordingly, all suitable modifications and equivalents are possible, while still falling within the true spirit and the scope of the invention, as defined by the appended claims.

In summary, the present invention relates to a system and method for performing a block auction. In a block auction, a block request is enabled to be executed against the plurality of quotes of different bidders, which comprise at least a part of the request volume. In accordance with the present invention, neither specification of the trade side of the request nor publication of the individual quotes submitted by bidders are required for performing the auction at an electronic trading system. Therefore, the auction can be performed anonymously and the trading of block requests comprising large volumes is enabled.

What is claimed is:

1. A method of performing a block auction in an electronic trading system for enabling execution of a single block request comprising a predetermined volume of a product against quotes of a plurality of market participants responding to the block request, the method comprising the steps of:
receiving a plurality of quotes in response to said block request for at least a part of the request volume, said quotes including price and volume information,
determining an indicative auction price by matching at least a part of the volume of said block request with the volumes and prices of said quotes, said indicative auction price being an indicator of the current market situation on the basis of the received quotes,
notifying the auction participants of the indicative auction price,
receiving modified quotes and notifying of the current indicative auction price updated on the basis of the current quotes, and
terminating the block auction by accepting the block trade for execution based on matching quotes underlying a current indicative auction price.

2. The method of claim 1, inhibiting a notification of the auction participants of the price and volume information of the individual quotes such that the price and volume information of the individual quotes is kept anonymous.

3. The method of claim 1, wherein said step of accepting the execution is performed automatically.

4. The method of claim 1, wherein said block request does not comprise side information indicating the side of the trade triggered by said block request.

5. The method of claim 1, further comprising a step of notifying the market participants about said block request.

6. The method of claim 1, wherein said block request further including side information indicating the side of the trade triggered by said block request.

7. The method of claim 6, further comprising
a step of notifying the market participants about said block request, and
a step of extracting said side information before notifying the market participants, in order to keep the side information anonymous.

8. The method of claim 6, wherein said block request further including a price limit condition.

9. The method of claim 8, further comprising
a step of notifying the market participants about said block request, and
a step of extracting said price limit condition before notifying the market participants, in order to keep the price limit condition anonymous.

10. The method of claim 1, wherein said block request further including a limit volume, said limit volume being less than or equal to said request volume.

11. The method of claim 10, further comprising
a step of notifying the market participants about said block request, and
a step of extracting said price limit condition before notifying the market participants, in order to keep the price limit condition anonymous.

12. The method of claim 10, wherein said step of determining an indicative auction price determining the indicative auction price by matching said limit volume included in said block request with the volumes and prices of said quotes.

13. The method of claim 8, wherein said step of accepting the execution is performed automatically, provided that the indicative auction price fulfils said price limit condition of said block request.

14. The method of claim 10, wherein said block request further including a price limit condition and said step of accepting the execution is automatically performed, provided that the indicative auction price fulfils said price limit condition of said block request and that said limit volume is completely executable.

15. The method of claim 1, wherein said quotes further comprising side information, said side information indicating, whether the quote is an ask quote or a bid quote.

16. The method of claim 15, wherein said step of determining an auction price comprising
a step of determining a first indicative auction price being an indicative bid price by matching the volume of said block request with the volumes and prices of the bid quotes, and
a step of determining a second indicative auction price being an indicative ask price by matching the volume of said block request with the volumes and prices of the ask quotes.

17. The method of claim 16, wherein said step of accepting the block trade for execution including a step of selecting either the current indicative bid price or the current indicative ask price, thereby automatically defining the side of the block trade as either selling or buying, respectively.

18. The method of claim 16, wherein said step of accepting the block trade for execution comprising a step of defining any other price than the current indicative bid price and the current indicative ask price together with specifying the side of the block trade, thereby accepting execution of at least a part of said request volume matching with quotes on the basis of said other price.

19. The method of claim 18, wherein said block request including a limit volume being less than or equal to said request volume, and said step of accepting the block trade for execution accepting execution of said limit volume against matching quotes on the basis of said other price.

20. The method of claim 18, wherein said other price must be larger than said indicative bid price, if the side of the block trade is specified as selling, and said other price must be smaller than said indicative ask price, if the side of the block trade is specified as buying.

21. The method of claim 1, wherein each of said quotes comprises a bid quote and an ask quote.

22. The method of claim 21, wherein said step of determining an auction price comprising
a step of determining a first indicative auction price being an indicative bid price by matching the volume of said block request with the volumes and prices of the bid quotes, and
a step of determining a second indicative auction price being an indicative ask price by matching the volume of said block request with the volumes and prices of the ask quotes.

23. The method of claim 1, further comprising a step of determining and the step of notifying an auction participant, whether the current quotes received from the auction participant are marketable.

24. The method of claim 23, wherein said block request further comprising side information, and wherein said marketability is determined and notified for both ask quotes and bid quotes, without taking into account said side information of said block request, to keep said side information anonymous.

25. The method of claim 1, wherein said indicative auction price being determined as the volume weighted average price of the matching current quotes.

26. The method of claim 1, wherein said indicative auction price being determined as the price of the matching quote that allows to fill the request volume or that maximizes the available volume.

27. The method of claim 1, further comprising the steps of determining and notifying a current executable volume together with said indicative auction price on the basis of the currently existing quotes.

28. The method of claim 27, wherein the current executable volume is being determined as the total volume of all currently matching quotes that would be executable.

29. The method of claim 1, further comprising the step of rejecting a block request if the request volume is smaller than a predetermined minimum request volume.

30. The method of claim 29, further comprising the step of rejecting quotes that are smaller than a predetermined minimum quote volume, said minimum quote volume being smaller than said minimum request volume.

31. The method of claim 1, wherein the method further setting a predetermined time window allowing modification of said quotes, the predetermined time window beginning upon the start of the auction and expiring after a predetermined time has elapsed or execution has been accepted.

32. The method of claim 31, wherein the length of said predetermined time window being adjusted dependent on the request volume.

33. The method of claim 31, wherein said step of determining an auction price is iteratively repeated during said time window, in order to permanently update the current indicative auction price.

34. The method of claim 31, further comprising a step of allowing to delete a quote during said predetermined time window.

35. The method of claim 31, wherein said block request further comprising a price limit condition, the method further comprising a step of allowing to modify said price limit condition of said block request during said predetermined time window.

36. The method of claim 35, wherein said block request further comprising a limit volume, the method further comprising a step of allowing to modify said limit volume of said block request during said predetermined time window.

37. The method of claim 31, wherein said predetermined time window comprises a first time window and a subsequent second time window, the method accepting additional market participants only during said first time window, and rejecting during said second time window quotes from market participants that did not have placed a current quote at the end of said first time window.

38. The method of claim 37, further comprising inhibiting to delete an existing quote during said second time window.

39. The method of claim 1, further comprising a step of communicating rating information indicating the reliability of a requester, said requester being the market participant placing the block request, to the market participants.

40. The method of claim 39, further comprising steps of automatically generating and updating said rating information on the basis of the data of a plurality of auctions triggered by said requester.

41. The method of claim 40, wherein said rating information comprising the percentage of accepted auctions through block requests received from the requester.

42. A method of performing a block auction in an electronic trading system for enabling execution of a single block request comprising a predetermined volume of a product against quotes of a plurality of market participants responding to the block request, the method comprising the steps of
notifying the market participants about said block request, wherein the notification does not include any side information of the block request,
receiving a plurality of quotes in response to said block request for at least a part of the request volume, said quotes including price, volume and side information, said side information indicating whether the quote is a bid quote or an ask quote,
determining an indicative bid price and an indicative ask price, by matching at least a part of the volume of said block request with the volumes and prices of the received bid quotes and the received ask quotes, respectively, said indicative bid price and said indicative ask price being an indicator of the current market situation on the basis of the received quotes, and
terminating the block auction by accepting the block trade for execution based on matching quotes underlying current indicative bid and ask prices.

43. The method of claim 42, wherein each of said plurality of quotes comprising an ask quote and a bid quote at the same time.

44. The method of claim 42, further comprising a step of notifying the auction participants of the determined indicative bid and ask prices.

45. The method of claim 44, further comprising a step of receiving modified quotes and notifying of the current indicative bid and ask prices updated on the basis of the current quotes.

46. The method of claim 42, inhibiting a notification of the auction participants of the price and volume information of the individual quotes such that the price and volume information of the individual quotes is kept anonymous.

47. The method of claim 42, wherein said step of accepting the execution is performed automatically.

48. The method of claim 42, wherein said block request does not comprise side information indicating the side of the trade triggered by said block request.

49. The method of claim 42, wherein said block request further including side information indicating the side of the trade triggered by said block request.

50. The method of claim 49, further comprising a step of extracting said side information before notifying the market participants, in order to keep the side information anonymous.

51. The method of claim 49, wherein said block request further including a price limit condition.

52. The method of claim 51, further comprising a step of extracting said price limit condition before notifying the market participants, in order to keep the price limit condition anonymous.

53. The method of claim 42, wherein said block request further including a limit volume, said limit volume being less than or equal to said request volume.

54. The method of claim 53, further comprising
a step of notifying the market participants about said block request, and
a step of extracting said price limit condition before notifying the market participants, in order to keep the price limit condition anonymous.

55. The method of claim 53, wherein said step of determining an indicative bid price and an indicative ask price determining the indicative prices by matching said limit volume included in said block request with the volumes and prices of said quotes.

56. The method of claim 51, wherein said step of accepting the execution is performed automatically, provided that either the indicative bid price or the indicative ask price fulfils said price limit condition of said block request.

57. The method of claim 53, wherein said block request further including a price limit condition and said step of accepting the execution is automatically performed, provided that either the indicative bid price or the indicative ask price fulfils said price limit condition of said block request and said limit volume is completely executable.

58. The method of claim 42, wherein said step of accepting the block trade for execution including the step of selecting either the current indicative bid price or the current indicative ask price, thereby automatically defining the side of the block trade as either selling or buying, respectively.

59. The method of claim 42, wherein said step of accepting the block trade for execution comprising the step of defining any other price than the current indicative bid price and the current indicative ask price together with specifying the side of the block trade, thereby accepting execution of at least a part of said request volume matching with quotes on the basis of said other price.

60. The method of claim 59, wherein said block request including a limit volume being less than or equal to said request volume, and said step of accepting the block trade for execution accepting execution of said limit volume against matching quotes on the basis of said other price.

61. The method of claim 59, wherein said other price must be larger than said indicative bid price, if the side of a block trade is specified as selling, and said other price must be smaller than said indicative ask price, if the side of the block trade is specified as buying.

62. The method of claim 42, further comprising a step of determining and a step of notifying an auction participant, whether the current quotes received from the auction participant are marketable.

63. The method of claim 62, wherein said block request further comprising side information, and wherein said marketability is determined and notified for both ask quotes and bid quotes, without taking into account said side information of said block request, to keep said side information anonymous.

64. The method of claim 42, wherein said indicative bid price and said indicative ask price being determined as the volume weighted average price of the matching current quotes.

65. The method of claim 42, wherein said indicative bid price and said indicative ask price being determined as the price of the matching bid and ask quote that allows to fill the request volume or that maximizes the available volume, respectively.

66. The method of claim 42, further comprising the steps of determining and notifying a current executable volume together with said indicative auction price on the basis of the currently existing quotes.

67. The method of claim 66, wherein the current executable volume is being determined as the total volume of all currently matching quotes that would be executable.

68. The method of claim 42, further comprising a step of rejecting a block request if the request volume is smaller than a predetermined minimum request volume.

69. The method of claim 68, further comprising a step of rejecting quotes that are smaller than a predetermined minimum quote volume, said minimum quote volume being smaller than said minimum request volume.

70. The method of claim 45, wherein the method further setting a predetermined time window allowing modification of said quotes, the predetermined time window beginning upon the start of the auction and expiring after a predetermined time has elapsed or execution has been accepted.

71. The method of claim 70, wherein the length of said predetermined time window being adjusted dependent on the request volume.

72. The method of claim 70, wherein said step of determining an auction price is iteratively repeated during said time window, in order to permanently update the current indicative auction price.

73. The method of claim 70, further comprising a step of allowing to delete a quote during said predetermined time window.

74. The method of claim 70, wherein said block request further comprising a price limit condition, the method further comprising a step of allowing to modify said price limit condition of said block request during said predetermined time window.

75. The method of claim 74, wherein said block request further comprising a limit volume, the method further comprising a step of allowing to modify said limit volume of said block request during said predetermined time window.

76. The method of claim 70, wherein said predetermined time window comprises a first time window and a subsequent second time window, the method accepting additional market participants only during said first time window, and rejecting during said second time window quotes from market participants that have not placed a current quote at the end of said first time window.

77. The method of claim 76, further comprising inhibiting to delete an existing quote during said second time window.

78. The method of claim 42, further comprising a step of communicating rating information indicating the reliability of a requester, said requester being the market participant placing the block request, to the market participants.

79. The method of claim 78, further comprising steps of automatically generating and updating said rating information on the basis of the data of a plurality of auctions triggered by said requester.

80. The method of claim 79, wherein said rating information comprising the percentage of accepted auctions through block requests received from the requester.

81. An electronic trading system for performing a block auction enabling execution of a single block request comprising a predetermined volume of a product against quotes of a plurality of market participants responding to the block request, the system comprising
a block request interface for receiving a block request including information of a predetermined volume of a product,
a block request memory for storing data representing said received block request,
a quote interface for receiving a plurality of quotes for at least a part of said predetermined volume in response to said block request, said quotes including price and volume information,
a quote memory for storing data representing said received quotes,
a processor for determining an auction indicative price by matching at least a part of the volume of said block request stored in said block request memory with the volumes and prices of said quotes stored in said quote memory, said indicative auction price being an indicator of the current market situation on the basis of the received quotes, wherein said processor permanently updating the indicative auction price to determine a current indicative auction price when said quote interface receiving new or modified quotes,
a notifying interface for notifying the auction participants of the determined current indicative auction price, and
a terminating unit for terminating the block auction by accepting the block trade based on matching quotes underlying a current indicative auction price.

82. The system of claim 81, wherein said quote memory being adapted to inhibit the market participants from accessing the data of the individual quotes.

83. The system of claim 81, wherein said notifying interface further being adapted to notify the market participants about said block request.

84. The system of claim 83, wherein said block request further including side information, the system further comprising an extractor for extracting said side information before notifying the market participants, in order to keep the side information anonymous.

85. The system of claim 84, wherein said block request further including a price limit condition, and said extractor further being adapted to extract said price limit condition before notifying the market participants, in order to keep the price limit condition anonymous.

86. The system of claim 81, wherein said block request further including a limit volume being less than or equal to the request volume, and said extractor further being adapted to extract said limit volume before notifying the market participants, in order to keep the limit volume anonymous.

87. The system of claim 86, wherein said processor determining the indicative auction price by matching said limit volume included in said block request with the volumes and prices of said quotes

88. The system of claim 81, wherein said quotes further comprising side information, said side information indicating, whether the quote is an ask quote or a bid quote.

89. The system of claim 88, wherein said processor being adapted to determine
a first indicative auction price being an indicative bid price by matching the volume of said block request with the volumes and prices of the bid quotes, and
a second indicative auction price being an indicative ask price by matching the volume of said block request with the volumes and prices of the ask quotes.

90. The system of claim 89, wherein said terminating unit including a selector for selecting either the current indicative bid price or the current indicative ask price, thereby automatically defining the side of the block trade as either selling or buying, respectively.

91. The system of claim 81, wherein each of said quotes comprises a bid quote and an ask quote.

92. The system of claim 91, wherein said processor being adapted to determine
a first indicative auction price being an indicative bid price by matching the volume of said block request with the volumes and prices of the bid quotes, and
a second indicative auction price being an indicative ask price by matching the volume of said block request with the volumes and prices of the ask quotes.

93. The system of claim 81, further comprising a first timer for defining a first predetermined period of time for receiving and modifying quotes after the block request has been received, wherein said processor iteratively repeating determination of the indicative auction price during said first predetermined period of time, in order to update the current indicative auction price.

94. The system of claim 93, further comprising a second timer for defining a second predetermined period of time after the first period of time has elapsed, wherein only quotes from the current auction participants but not from other market participants are allowed, and wherein said processor iteratively repeating determination of the indicative auction price during said second predetermined period of time, in order to update the current indicative auction price.

95. The system of claim 93, further comprising an adjustment unit for adjusting the length of said first predetermined period of time, defined by said first timer, dependent on the request volume.

96. The system of claim 94, further comprising an adjustment unit for adjusting the length of said first and said second predetermined period of time defined by said first and said second timer, respectively, dependent on the request volume.

97. The system of claim 95, further comprising a requester memory for storing requester data reflecting the behavior of a requester during a plurality of auctions, said requester being a market participant from whom said block request has been received, and a requester rating calculator for calculating a rating of the requester on the basis of the requester data of a plurality of auctions triggered by the requester, said rating indicating the reliability of the requester.

98. An electronic trading system for performing a block auction enabling execution of a single block request comprising a predetermined volume of a product against quotes of a plurality of market participants responding to the block request, the system comprising
a block request interface for receiving a block request including information of a predetermined volume of a product,
a block request memory for storing data representing said received block request,
a notifying interface for notifying the market participants about said block request, wherein the notification does not include any side information of the block request,
a quote interface for receiving a plurality of quotes in response to said block request for at least a part of the request volume, said quotes including price, volume and side information, said side information indicating whether the quote is a bid quote or an ask quote,
a quote memory for storing data representing said receives quotes,
a processor for determining an indicative bid price and an indicative ask price, by matching at least a part of the volume of said block request with the volumes and prices of the received bid quotes and the received ask quotes, respectively, said indicative bid price and said indicative ask price being an indicator of the current market situation on the basis of the received quotes, and
a terminating unit for terminating the block auction by accepting the block trade for execution based on matching quotes underlying current indicative bid and ask prices.

99. The system of claim 98, wherein each of said plurality of quotes comprising an ask quote and a bid quote at the same time.

100. The system of claim 98, wherein said notifying interface being adapted to notify the auction participants of the determined indicative bid and ask prices.

101. The system of claim 100, wherein said processor being adapted to permanently update the indicative bid and ask prices, when said quote interface receiving new or modified quotes.

102. The system of claim 98, wherein said quote memory being adapted to inhibit the market participants from accessing the data of the individual quotes.

103. The system of claim 98, wherein said block request further including side information, the system further comprising an extractor for extracting said side information before notifying the market participants, in order to keep the side information anonymous.

104. The system of claim 103, wherein said block request further including a price limit condition, and said extractor further being adapted to extract said price limit condition before notifying the market participants, in order to keep the price limit condition anonymous.

105. The system of claim 98, wherein said block request further including a limit volume being less than or equal to the request volume, and said extractor further being adapted to extract said limit volume before notifying the market participants, in order to keep the limit volume anonymous.

106. The system of claim 105, wherein said processor determining the indicative bid price and the indicative ask price by matching said limit volume included in said block request with the volumes and prices of said quotes.

107. The system of claim 98, wherein said terminating unit including a selector for selecting either the current indicative bid price or the current indicative ask price, thereby automatically defining the side of the block trade as either selling or buying, respectively.

108. The system of claim 98, further comprising a first timer for defining a first predetermined period of time for receiving and modifying quotes after the block request has been received, wherein said processor iteratively repeating determination of the indicative bid and ask prices during said first predetermined period of time, in order to update the current indicative bid and ask prices.

109. The system of claim 108, further comprising a second timer for defining a second predetermined period of time after the first period of time has elapsed, wherein only quotes from the current auction participants but not from other market participants are allowed, and wherein said processor iteratively repeating determination of the indicative bid and ask prices during said second predetermined period of time, in order to update the current indicative bid and ask prices.

110. The system of claim 108, further comprising an adjustment unit for adjusting the length of said first predetermined period of time, defined by said first timer, dependent on the request volume.

111. The system of claim 109, further comprising an adjustment unit for adjusting the length of said first and said second predetermined period of time defined by said first and said second timer, respectively, dependent on the request volume.

112. The system of claim 98, further comprising a requester memory for storing requester data reflecting the behavior of a requester during a plurality of auctions, said requester being a market participant from whom said block request has been received, and a requester rating calculator for calculating a rating of the requester on the basis of the requester data of a plurality of auctions triggered by the requester, said rating indicating the reliability of the requester.
